(19) United States
(12) Patent Application Publication
(10) Pub. No.: US 2021/0259443 A1
(43) Pub. Date: Aug. 26, 2021

(54) EDIBLE CUTLERY AND A METHOD OF MANUFACTURE THEREOF

(71) Applicants: Incredible Eats Inc., Milpitas, CA (US); Trishula, Vadodara (IN)

(72) Inventors: Kruvilkumar Rajendrakumar Patel, Vadodara (IN); Dinesh Kumar Tadepalli, Milpitas, CA (US)

(21) Appl. No.: 17/183,838

(22) Filed: Feb. 24, 2021

Related U.S. Application Data
(60) Provisional application No. 62/981,160, filed on Feb. 25, 2020.

(51) Int. Cl. A47G 21/04; A23P 30/10; A21D 13/48; A47G 21/02; A47G 21/06; A47G 21/18

(52) U.S. Cl. CPC A47G 21/04; A23P 30/10; A21D 13/48; A47G 2400/105; A47G 21/103; A47G 21/181; A47G 21/023

(57) ABSTRACT

A piece of edible cutlery and a method to create the piece of edible cutlery is described. The piece of edible cutlery includes at least a main flour and a binder. The main flour is a wheat flour, a rice flour, a corn flour, a chickpea flour, an oat flour, and/or a millet flour. The binder facilitates gelatinization of a gelatin content in the main flour to enable the piece of edible cutlery to be formed. The binder is a rice flour, an oat flour, a soy flour, a corn flour, a chickpea flour, a tapioca starch, and/or a cassava starch. The piece of edible cutlery is a spoon, a dessert spoon, a fork, a knife, a spork, a straw, a chopstick, an ice cream stick, a coffee stirrer, a cup, a bowl, and/or a plate.

### CROSS-REFERENCE TO RELATED APPLICATIONS

The present application is a U.S. Non-Provisional Patent Application that claims priority to U.S. Provisional Application No. 62/981,160, filed Feb. 25, 2020, the entire contents of which are being incorporated herein by reference.

### FIELD OF THE EMBODIMENTS

This invention pertains to edible cutlery and a method of manufacture thereof.

### BACKGROUND OF THE EMBODIMENTS

Typically, only 9% of single-use plastic products are recycled. Therefore, oceans and landfills are becoming inundated with single-use plastic products. At the current rate of single-use plastic products, by 2050, there may be more plastic than fish in the oceans by weight. Further complicating the process is the expense and infrastructure requirements for recycling single-use plastic products.

Examples of related art are described below:

US20200196786A1 describes an edible utensil for the consumption of liquid food. The edible utensil includes: a hollow, substantially tubular body with a first end, a second end opposite the first end, an outer surface that is substantially hose-like in form and an inner surface that is formed substantially coaxially with the outer surface and forms a food flow channel, characterized in that the dimensions of the tubular body are such that the edible utensil can be used as a drinking straw for the intake of liquid food through the food flow channel. The tubular body is made of a pasta dough or pasta-dough-based material and is subjected to a thermochemical treatment that results in it being possible to consume the edible utensil like an easily digestible pasta product both during the intake of the liquid food and after the intake of the liquid food.

WO2018157119A1 and US20200113193A1 describe edible and biodegradable compositions that can be made into utensils. In specific examples, the edible utensil is prepared from a dough comprising: a) 12 wt. % to 27 wt. % corn flour, b) 6 wt. % to 17 wt. % rice flour, c) 6 wt. % to 13 wt. % soy flour, d) 18 wt. % to 33 wt. % high gluten flour, and e) 30 wt. % to 40 wt. % liquid; or a) 18 wt. % to 27 wt. % corn flour, b) 18 wt. % to 27 wt. % rice flour, c) 9 wt. % to 17 wt. % soy flour, d) 3 wt. % to 6 wt. % tapioca flour, e) 3 wt. % to 5 wt. % potato flour, and f) 30 wt. % to 40 wt. % liquid; or a) 12 wt. % to 27 wt. % corn flour, b) 6 wt. % to 17 wt. % rice/oat flour, c) 6 wt. % to 13 wt. % soy/peanut/flaxseed flour, d) 18 wt. % to 33 wt. % high gluten flour, and e) 30 wt. % to 40 wt. % liquid; or a) 12 wt. % to 27 wt. % corn flour, b) 6 wt. % to 10 wt. % rice/oat flour, c) 3 wt. % to 6 wt. % barley flour, d) 18 wt. % to 33 wt. % high gluten flour, e) 6 wt. % to 13 wt. % soy/peanut/flaxseed flour, and f) 30 wt. % to 40 wt. % liquid; or a) 12 wt. % to 27 wt. % corn flour, b) 6 wt. % to 10 wt. % rice flour, c) 6 wt. % to 10 wt. % oat flour, d) 18 wt. % to 33 wt. % high gluten flour, e) 6 wt. % to 13 wt. soy/peanut/flaxseed flour, and f) 30 wt. % to 40 wt. % liquid; or a) 8 wt. % to 18 wt. % rice flour, b) 5 wt. % to 10 wt. % barley flour, c) 30 wt. % to 40 wt. % high gluten flour, d) 8 wt. % to 18 wt. % soy/peanut/flaxseed flour, and e) 30 wt. % to 40 wt. % liquid.

US20200069095A1 describes an edible straw that enables intake of water, as well as active ingestion of active ingredients of an edible part during use of the straw, and can be eaten after use of the straw.

IN201841017039A describes edible, gluten-free, eco-friendly and biodegradable cups, utensils, and other tableware, which are made with flour of one or more protein rich edible legumes. The products can contain or handle hot (up to 90° C.) or cold liquid or solid foods for minimum of 1 hour, without any leaks or breakage. The products do not require any internal or external, edible or non-edible, layer of waterproofing coatings.

U.S. Pat. No. 8,323,709B2 describes an appliance iron for making edible spoons that dissociate into consumable predetermined clumps in order to prevent a dissociating into random granules that would make a consumption more difficult.

CN203633920U describes an edible straw. The edible straw comprises a starch main body and edible colloid layers. The starch main body adopts a hollow tubular structure. The edible colloid layers are respectively arranged on the inner surface and the outer surface of the starch main body. The starch main body is completely wrapped by the edible colloid layers.

US20140087029A1 describes compositions comprising a dessert attached to a utensil by an edible attachment means.

WO2012098448A1 describes eco-friendly, biodegradable, and edible cutleries, chopsticks, and all utensils used to lift food into mouth. The products are made of flours having about 65% w/w or above carbohydrate content and contain no added preservatives or chemical additives. The products have a shelf life of a year or more.

US20070292566A1 describes a lollipop with a conventional stem or handle and an edible part in the shape of a spoon for administering liquid medications.

WO9620604A1 describes a method for preparing an edible eating or drinking utensil, such as straw, chop-stick, stirrer, or cup. The method includes: producing an edible mixture, forming an edible utensil from the edible mixture, and heating the edible utensil to cure it and provide it with a structure, which is substantially resistant to at least one of deformation and disintegration due to contact with at least one of a drinkable liquid and an edible food for an acceptance time period.

USD0632046S describes an edible spoon. USD0212070S describes an edible snack product. USD0193541S and USD0193542S describe an edible serving spoon.

None of the art described above art addresses all the issues that the present disclosure does.

### SUMMARY OF THE EMBODIMENTS

In one general example, the present disclosure provides edible cutlery comprising a main flour and a binder.

In another general example, the present disclosure provides a method of manufacturing edible cutlery.

These and other benefits realizable from various examples of the present invention will be apparent from the description that follows.

### BRIEF DESCRIPTION OF THE DRAWINGS

The features and advantages of various examples of the present invention, and the manner of attaining them, will become more apparent, and the examples will be better understood by reference to the following description of examples taken in conjunction with the accompanying drawing, wherein:

FIG. 1A is a bottom view of a first embodiment of an edible spoon, according to at least some embodiments disclosed herein.

FIG. 1B is a top view of the first embodiment of the edible spoon of FIG. 1A, according to at least some embodiments disclosed herein.

FIG. 1C is a side view of the first embodiment of the edible spoon of FIG. 1A, according to at least some embodiments disclosed herein.

FIG. 1D is a perspective view of the first embodiment of the edible spoon of FIG. 1A, according to at least some embodiments disclosed herein.

FIG. 1E is a bottom exploded view of the first embodiment of the edible spoon of FIG. 1A, according to at least some embodiments disclosed herein.

FIG. 2A is a bottom view of a second embodiment of an edible spoon according to the present disclosure, according to at least some embodiments disclosed herein.

FIG. 2B is a top view of the second embodiment of the edible spoon of FIG. 2A, according to at least some embodiments disclosed herein.

FIG. 2C is a side view of the second embodiment of the edible spoon of FIG. 2A, according to at least some embodiments disclosed herein.

FIG. 2D is a perspective view of the second embodiment of the edible spoon of FIG. 2A, according to at least some embodiments disclosed herein.

FIG. 2E is a bottom exploded view of the second embodiment of the edible spoon of FIG. 2A, according to at least some embodiments disclosed herein.

FIG. 3A is a perspective view of an edible chopstick, according to at least some embodiments disclosed herein.

FIG. 3B is a side view of the edible chopstick of FIG. 3A, according to at least some embodiments disclosed herein.

FIG. 4A is a perspective view of an edible tablespoon, according to at least some embodiments disclosed herein.

FIG. 4B is a top view of the edible tablespoon of FIG. 4A, according to at least some embodiments disclosed herein.

FIG. 4C is a side view of the edible tablespoon of FIG. 4A, according to at least some embodiments disclosed herein.

FIG. 4D is a side view of the edible tablespoon of FIG. 4A, according to at least some embodiments disclosed herein.

FIG. 5A is a perspective view of an edible straw, according to at least some embodiments disclosed herein.

FIG. 5B is a side view of the edible straw of FIG. 5A, according to at least some embodiments disclosed herein.

FIG. 5C is a perspective view of an end of the edible straw of FIG. 5A, according to at least some embodiments disclosed herein.

FIG. 6A is a perspective view of an edible spork, according to at least some embodiments disclosed herein.

FIG. 6B is a top view of the edible spork of FIG. 6A, according to at least some embodiments disclosed herein.

FIG. 6C is a side view of the edible spork of FIG. 6A, according to at least some embodiments disclosed herein.

FIG. 6D is a side view of the edible spork of FIG. 6A, according to at least some embodiments disclosed herein.

FIG. 7A is a perspective view of an edible angled spoon, according to at least some embodiments disclosed herein.

FIG. 7B is a bottom view of the edible angled spoon of FIG. 7A, according to at least some embodiments disclosed herein.

FIG. 7C is a side view of the edible angled spoon of FIG. 7A, according to at least some embodiments disclosed herein.

FIG. 7D is a side view of the edible angled spoon of FIG. 7A, according to at least some embodiments disclosed herein.

FIG. 8A is a perspective view of a first embodiment of an edible ice cream scoop, according to at least some embodiments disclosed herein.

FIG. 8B is a top view of the first embodiment of the edible ice cream scoop of FIG. 8A, according to at least some embodiments disclosed herein.

FIG. 8C is a side view of the first embodiment of the edible ice cream scoop of FIG. 8A, according to at least some embodiments disclosed herein.

FIG. 8D is a side view of the first embodiment of the edible ice cream scoop of FIG. 8A, according to at least some embodiments disclosed herein.

FIG. 9A is a perspective view of a second embodiment of an edible ice cream scoop, according to at least some embodiments disclosed herein.

FIG. 9B is a bottom view of the second embodiment of the edible ice cream scoop of FIG. 9A, according to at least some embodiments disclosed herein.

FIG. 9C is a side view of the second embodiment of the edible ice cream scoop of FIG. 9A, according to at least some embodiments disclosed herein.

FIG. 9D is a top view of the second embodiment of the edible ice cream scoop of FIG. 9A, according to at least some embodiments disclosed herein.

FIG. 9E is a side view of the second embodiment of the edible ice cream scoop of FIG. 9A, according to at least some embodiments disclosed herein.

FIG. 10A is a perspective view of an edible soup spoon, according to at least some embodiments disclosed herein.

FIG. 10B is a top view of the edible soup spoon of FIG. 10A, according to at least some embodiments disclosed herein.

FIG. 10C is a side view of the edible soup spoon of FIG. 10A, according to at least some embodiments disclosed herein.

FIG. 10D is a side view of the edible soup spoon of FIG. 10A, according to at least some embodiments disclosed herein.

FIG. 11A is a perspective view of an edible drink stick, according to at least some embodiments disclosed herein.

FIG. 11B is a perspective view of the edible drink stick of FIG. 11A, according to at least some embodiments disclosed herein.

FIG. 11C is a side view of the edible drink stick of FIG. 11A, according to at least some embodiments disclosed herein.

FIG. 12A is a perspective view of an edible drink cap, according to at least some embodiments disclosed herein.

FIG. 12B is a top view of the edible drink cap of FIG. 12A, according to at least some embodiments disclosed herein.

FIG. 12C is a bottom view of the edible drink cap of FIG. 12A, according to at least some embodiments disclosed herein.

FIG. 12D is a side view of the edible drink cap of FIG. 12A, according to at least some embodiments disclosed herein.

FIG. 12E is a side view of the edible drink cap of FIG. 12A, according to at least some embodiments disclosed herein.

Corresponding reference characters indicate corresponding parts throughout the several views. The exemplifications set out herein illustrate certain examples, in one form, and such exemplifications are not to be construed as limiting the scope of the examples in any manner.

### DESCRIPTION OF THE PREFERRED EMBODIMENTS

Certain exemplary aspects of the present invention will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present invention is defined solely by the claims. The features illustrated or described in connection with one exemplary aspect may be combined with the features of other aspects. Such modifications and variations are intended to be included within the scope of the present invention.

Prior biodegradable and compostable cutlery are made of processed corn or other starches in the form of derived polylactic acid (PLA). However, the prior biodegradable and compostable cutlery may only be compostable in industrial composting facilities and the lack of infrastructure (or expensive thereof) to compost the prior biodegradable and compostable cutlery can eliminate potential benefits. Additionally, the appearance of the prior biodegradable and compostable cutlery may be undesirable as they can appear similar to single-use plastic cutlery where many composting facilities will reject the prior biodegradable and compostable cutlery as they mistakenly believe they are plastic. Further, the output of the industrial compost facilities may not be accepted by farmers due to the presence of PLA which may not be considered all natural. Further, additional prior biodegradable and compostable cutlery may be too hard and not soften such that it may not be eaten after use.

Thus, edible cutlery are provided which can be used similar to single-use plastic products and thereafter can soften to be consumed as food or easily composted in a manner similar to typical food wastes. For example, the edible cutlery according to the present disclosure can be biodegradable in, for example, less than 40 days, such as, for example, less than 20 days. Additionally, a method of manufacturing the edible cutlery is provided herein.

To biodegrade the edible cutlery according to the present disclosure, the edible cutlery can be placed in a container sized and configured to retain a desired amount of heat for effective microbial activity and infiltration of microbes throughout the compost. The edible cutlery can be mixed with food scraps, greens, or other compostable materials to form a mixture with a suitable amount of carbon to nitrogen to effectuate the biodegradation of the mixture. Optionally, the mixture can be manually broken down (e.g., chopped) to enhance exposed surface area of the mixture and the mixture can be moistened with water. The mixture can be turned every 2-3 days. After the mixture, including the edible cutlery has biodegraded into soil, it can be used in a garden, flowers, potter plants, a lawn, or other use.

An example of edible cutlery according to the present disclosure comprises a main flour and a binder. The main flour can comprise a main grain flour comprising 50%-70% starch by total dry weight of the main flour (e.g., 60% starch by dry weight), such as, for example, wheat flour (e.g., all natural wheat flour), rice flour, millet flour, or a combination thereof. The binder can comprise brown rice flour, oat flour, soy flour, corn flour, chickpea flour, tapioca starch, cassava starch, guar gum or a combination thereof. The binder can facilitate gelatinization of the gelatin content in the main flour to enable the edible cutlery to be formed. The main flour and the binder can be suitable for human consumption. The edible cutlery can comprise 80 weight percent to 98 weight percent main flour based on the total dry weight percent of the edible cutlery and the balance can comprise binder and optionally additional ingredients. Example compositions of edible cutlery are provided in Table 1 below.

TABLE 1

| | Example Range 1 | Example Range 2 | Example Formula A | Example Formula B | Example Formula C |
|---|---|---|---|---|---|
| | (Wt % per the | (Wt % per the | (Wt % per the | (Wt % per the | (Wt % per the |
| | dry weight of the | dry weight of the | dry weight of the | dry weight of the | dry weight of the |
| Ingredient | edible cutlery) | edible cutlery) | edible cutlery) | edible cutlery) | edible cutlery) |
| Main Flour | 80-98 | 92-96 | 92 | 96 | 95 |
| Binder | 2-20 | 4-8 | 8 | 4 | 5 |

Additional examples of the composition of edible cutlery are provided in Table 2 below.

TABLE 2

| | Example Range 1 | Example Range 2 | Example Formula D | Example Formula E | Example Formula F |
|---|---|---|---|---|---|
| | (Wt % per the | (Wt % per the | (Wt % per the | (Wt % per the | (Wt % per the |
| | dry weight of the | dry weight of the | dry weight of the | dry weight of the | dry weight of the |
| Ingredient | edible cutlery) | edible cutlery) | edible cutlery) | edible cutlery) | edible cutlery) |
| Unbleached | 80-98 | 92-96 | 92 | 96 | 95 |
| Wheat Flour | | | | | |
| Brown Rice flour | 0.8-8 | 1.6-3.2 | 3.2 | 1.6 | 2 |
| Corn flour | 0.6-6 | 1.2-2.4 | 2.4 | 1.2 | 1.5 |
| Chickpea flour | 0.4-4 | 0.8-1.6 | 1.6 | 0.8 | 1 |
| Oat flour | 0.2-2 | 0.4-0.8 | 0.8 | 0.4 | 0.5 |

The edible cutlery can comprise additional ingredients, such as, for example, flavorings (e.g., all natural flavors) and sweeteners. The flavorings can comprises at least one of salt, black pepper, mint, caraway, cumin, curry, vanilla, and cocoa powder. In various examples where the edible cutlery comprises flavoring, the flavoring in the edible cutlery may not alter the taste of the food consumed with the spoon but may only be tasted when the edible cutlery itself is consumed. For example, the flavoring content may be kept to a desired level or an outer layer of the edible cutlery can comprise less flavoring (if any) than an inner layer of the edible cutlery such that the edible cutlery may have to be broken prior to tasting the flavoring. The sweeteners can comprise at least one of sugar (e.g., all natural cane sugar), sorbitol, and maltodextrin. In certain examples, the edible cutlery can comprise sodium alginate. In various examples, the edible cutlery can comprise less than or equal to 1% by total weight of the edible cutlery of sorbitol, maltodextrin, sodium alginate, or a combination thereof.

To form the edible cutlery according to the present disclosure, the main flour and binder are mixed with water at a ratio in a desired range of dry ingredients (e.g., main flour, binder, additional ingredients) to water to form a dough. The dough can be kneaded and then rolled into a flat sheet. This flat sheet of dough is then cut precisely to a desired cutlery shape on a conveyer belt while making sure a proper amount of thickness is preserved from multiple quality checks. The cut dough is then placed in a stainless-steel mold to preserve the shape of the desired cutlery before heating. The mold also compresses the dough inside to reduce surface irregularities on the product. The compressed mold with the dough inside can be placed in an oven for a temperature and time suitable to reduce the water content in the dough (e.g., to less than 1% by total weight of the dough) to form the edible cutlery. Thereafter, the edible cutlery can be removed from the molds and subjected to quality control, such as, for example, determining if the cutlery has the proper shape, smoothness, texture, strength, and/or hardness. This inspection can be performed visually and by feel of the edible cutlery while prepping the cutlery for wrapping. Then, the edible cutlery can be individually wrapped in paper.

The composition, process of manufacture, and shape of the edible cutlery can enable the edible cutlery to withstand exposure to hot foods (e.g., sitting in hot soup) or cold foods (e.g., scooping ice cream). The edible cutlery can at least partially degrade after a desired time period to enable the edible cutlery soft enough for consumption. For example, the edible cutlery according to the present disclosure may soften in hot foods in a time range of 15 minutes to 30 minutes. In various examples, the edible cutlery according to the present disclosure may soften in cold foods in a time range of 45 minutes to 120 minutes.

The edible cutlery can be a device configured for consuming food and can be suitable for human consumption. For example, the edible cutlery described herein can comprise at least one of: a spoon, a fork, a knife, a spork, a straw, a chopstick, an ice cream stick, a drink stirrer, a drink cap, a cup, a bowl, and a plate.

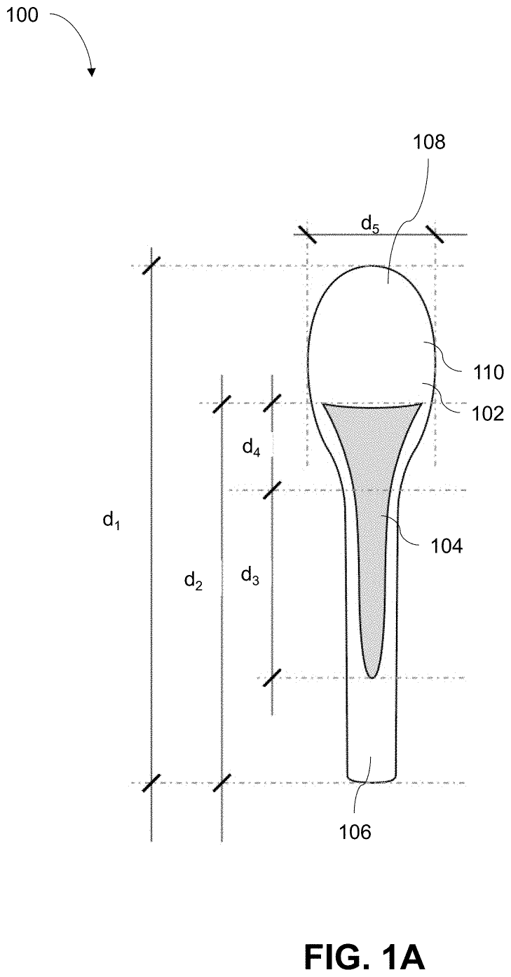

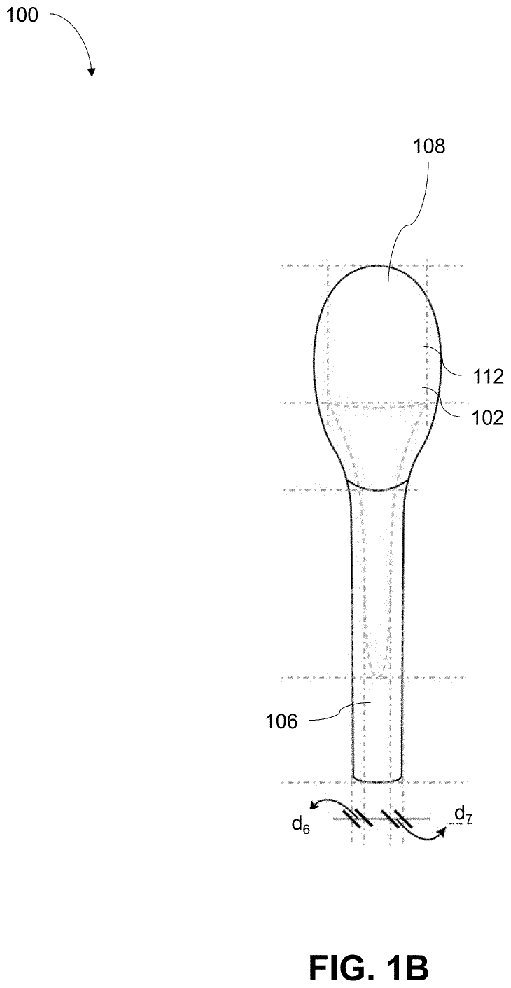

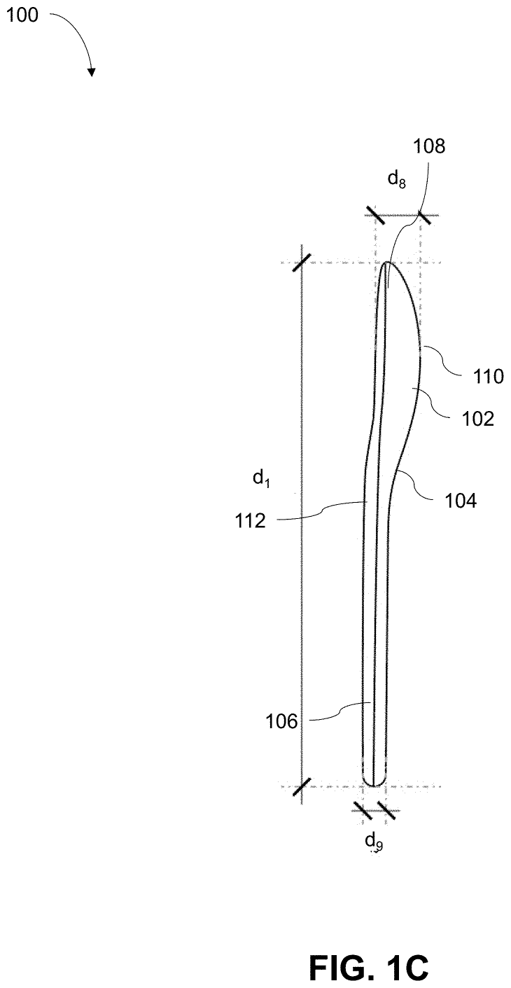

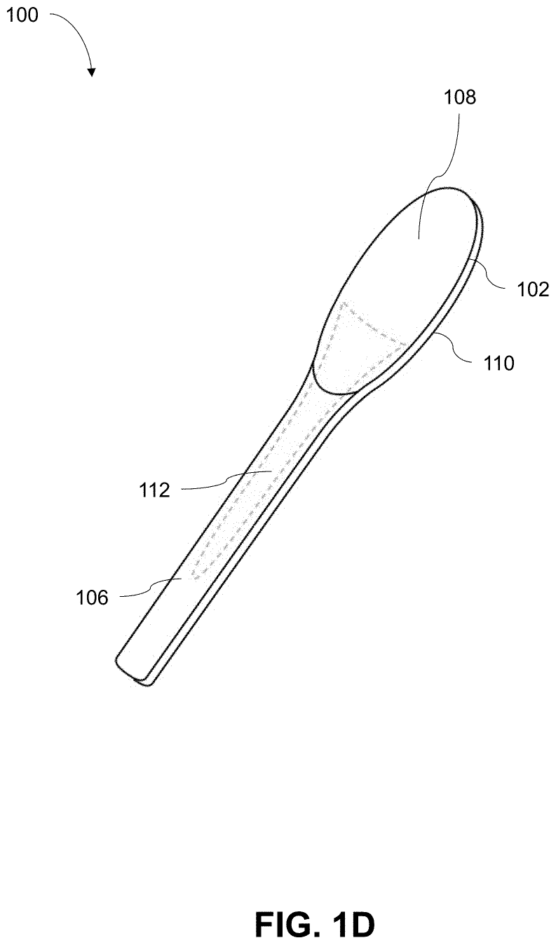

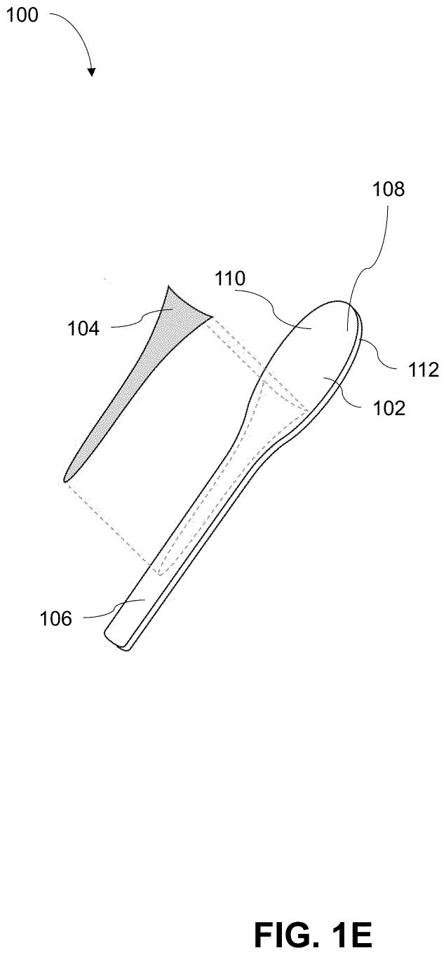

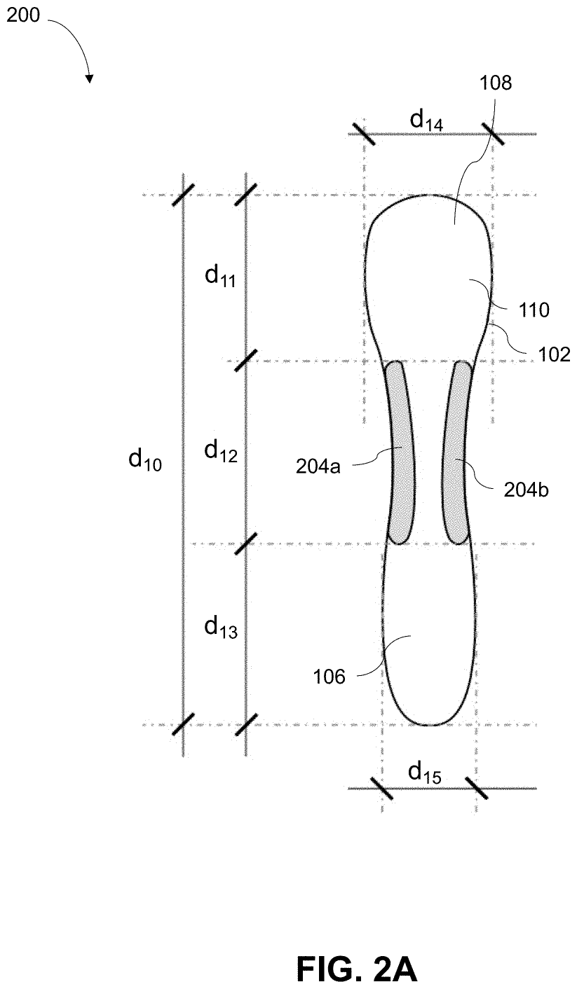

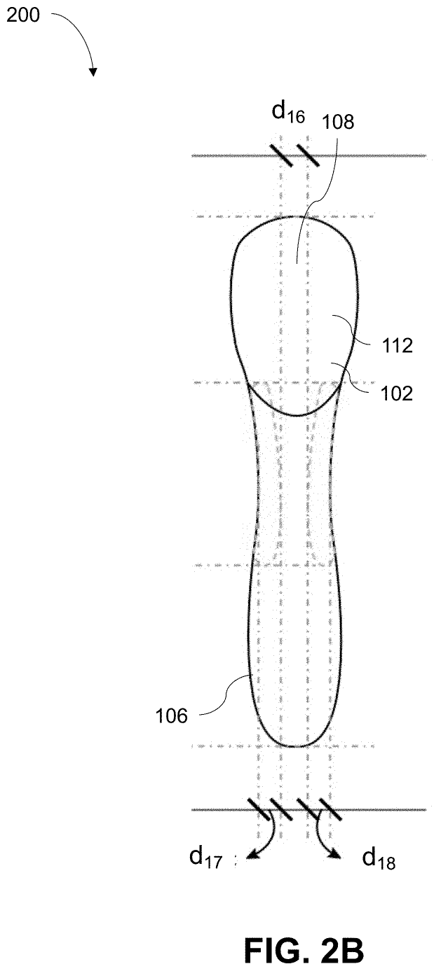

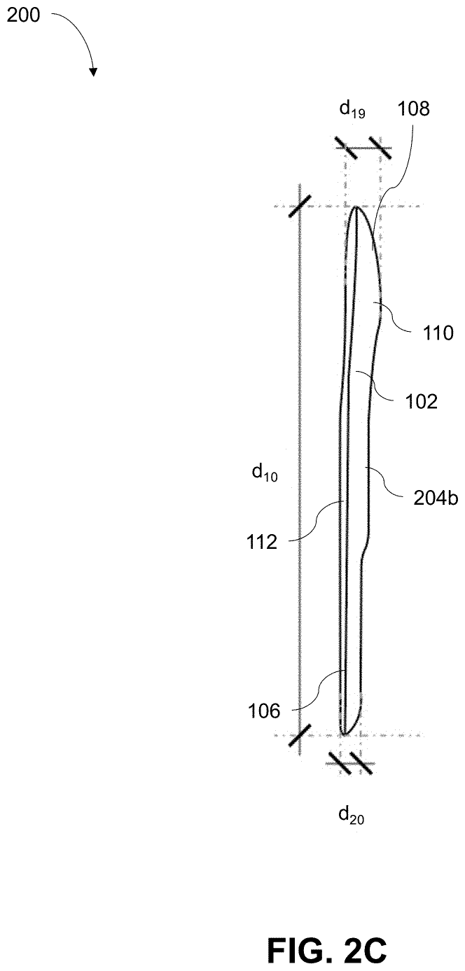

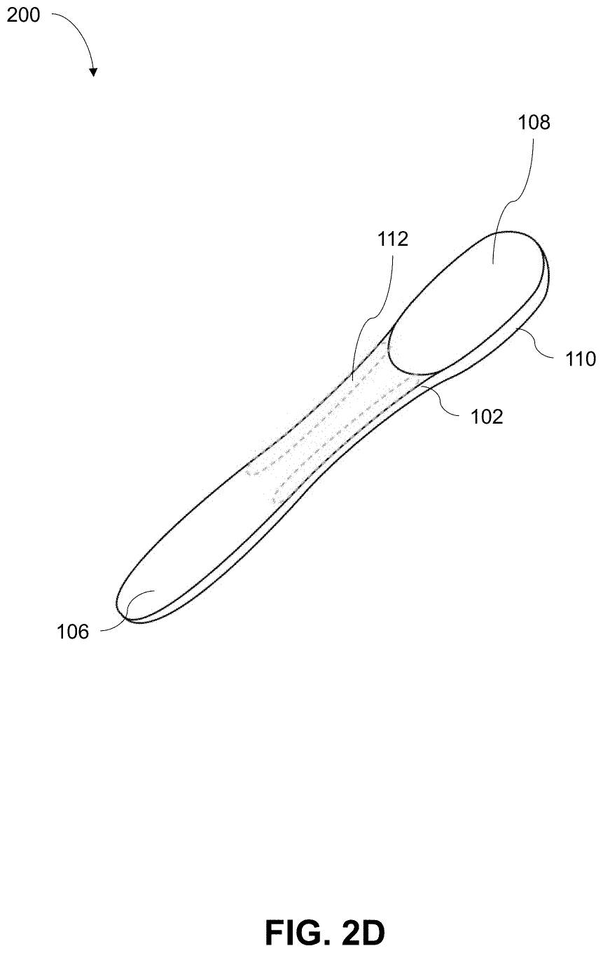

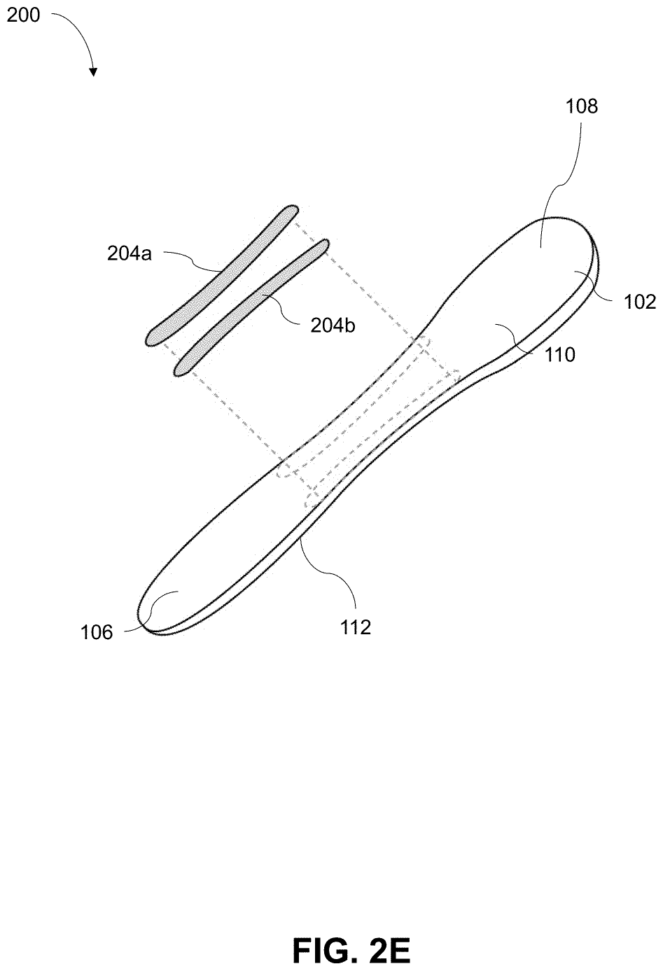

For example, the edible cutlery can be an edible spoon as shown in FIG. 1A, FIG. 1B, FIG. 1C, FIG. 1D, FIG. 1E, FIG. 2A, FIG. 2B, FIG. 2C, FIG. 2D, and FIG. 2E. As illustrated in FIG. 1A, FIG. 1B, FIG. 1C, FIG. 1D, and FIG. 1E, a first embodiment of an edible spoon 100 (“spoon 100”) can comprise a body 102 and a support 104 and have various dimensions d₁-d₉, such as those provided in Table 3 below.

The body 102 of the spoon 100 can comprise a handle region 106, a head region 108, a first surface 110, and a second surface 112. The support 104 can extend outwardly from first surface 110 and along at least a portion of the handle region 106 and at least a portion of the head region 108. The support 104 can support the head region 108 while holding the spoon 100 on the handle region 106. The support 104 can strengthen the spoon 100 so that the spoon 100 can still be operable after exposure to hot foods and/or cold foods. The support 102 can extend from a surface 102a of the body 102 and can be integral with the body 102. For example, the body 102 and support 104 can be a single, continuous piece. In various examples, the body 102 and the support 104 can comprise the same material composition. In certain examples, the spoon 100 can be a tablespoon.

Referring to FIG. 2A, FIG. 2B, FIG. 2C, FIG. 2D, and FIG. 2E, a second embodiment of an edible spoon 200 (“spoon 200”) can comprise two supports 204a and 204b and have various dimensions d₁₀-d₂₀ such as those provided in Table 3 below. The supports 204a and 204b can be spaced apart and, in various examples, can be mirror images of each other. The supports 204a and 204b can extend outwardly from first surface 110 and along at least a portion of the handle region 106 and at least a portion of the head region 108. In certain examples, the spoon 200 can be a dessert spoon.

TABLE 3

| | Range 1 | Range 1 | Range 2 | Range 2 |
|---|---|---|---|---|
| Dimension | (centimeter (cm)) | (millimeter (mm)) | (cm) | (mm) |
| d₁ | 12-13 | 120-130 | 11-14 | 110-114 |
| d₂ | 9-10 | 90-100 | 8-11 | 80-110 |
| d₃ | 5-6 | 50-60 | 4-7 | 40-70 |
| d₄ | 1.5-2.5 | 15-25 | 1-3 | 10-30 |
| d₅ | 3.8-4.2 | 38-42 | 3.5-4.5 | 34-45 |
| d₆ | 0.4-0.6 | 4-6 | 0.3-0.7 | 3-7 |
| d₇ | 0.4-0.6 | 4-6 | 0.3-0.7 | 3-7 |
| d₈ | 1.3-1.7 | 13-17 | 1.1-1.9 | 11-19 |
| d₉ | 0.4-0.6 | 4-6 | 0.3-0.7 | 3-7 |
| d₁₀ | 10.5-11.5 | 105-115 | 10-12 | 100-120 |
| d₁₁ | 2.8-3.2 | 28-32 | 2.5-3.5 | 25-35 |
| d₁₂ | 3.8-4.2 | 38-42 | 3.5-4.5 | 35-45 |
| d₁₃ | 3.8-4.2 | 38-42 | 3.5-4.5 | 35-45 |
| d₁₄ | 2.6-2.8 | 26-28 | 2.5-3 | 25-30 |
| d₁₅ | 2.6-2.8 | 26-28 | 2.5-3 | 25-30 |
| d₁₆ | 0.8-1.2 | 8-12 | 0.7-1.3 | 7-13 |
| d₁₇ | 0.3-0.4 | 3-4 | 0.3-0.5 | 3-5 |
| d₁₈ | 0.3-0.4 | 3-4 | 0.3-0.5 | 3-5 |
| d₁₉ | 0.9-1.1 | 9-11 | 0.8-1.4 | 8-14 |
| d₂₀ | 0.3-0.5 | 3-5 | 0.3-0.7 | 3-7 |

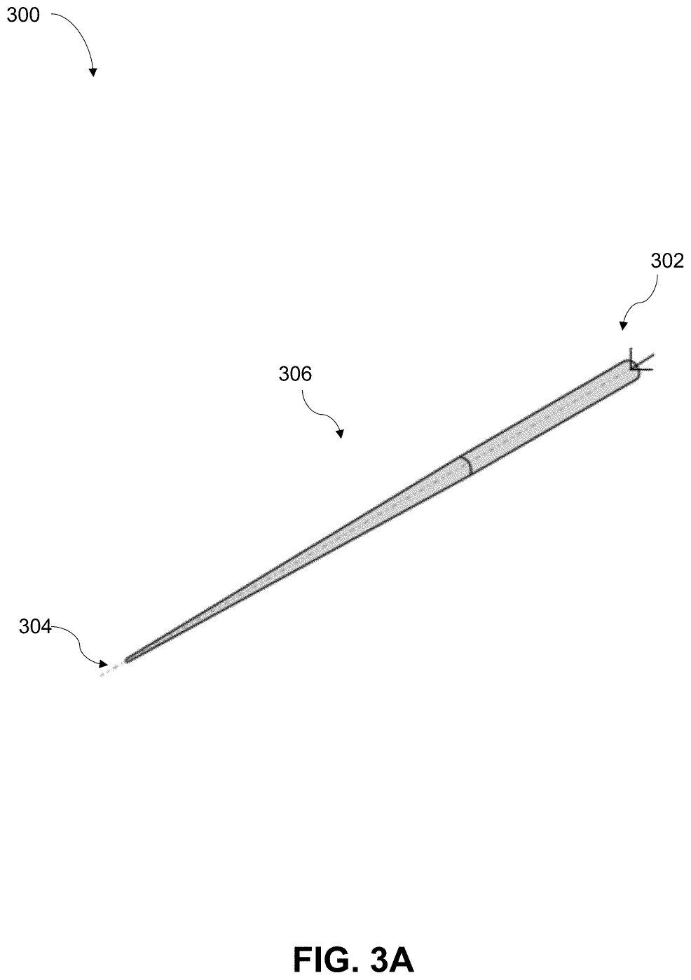

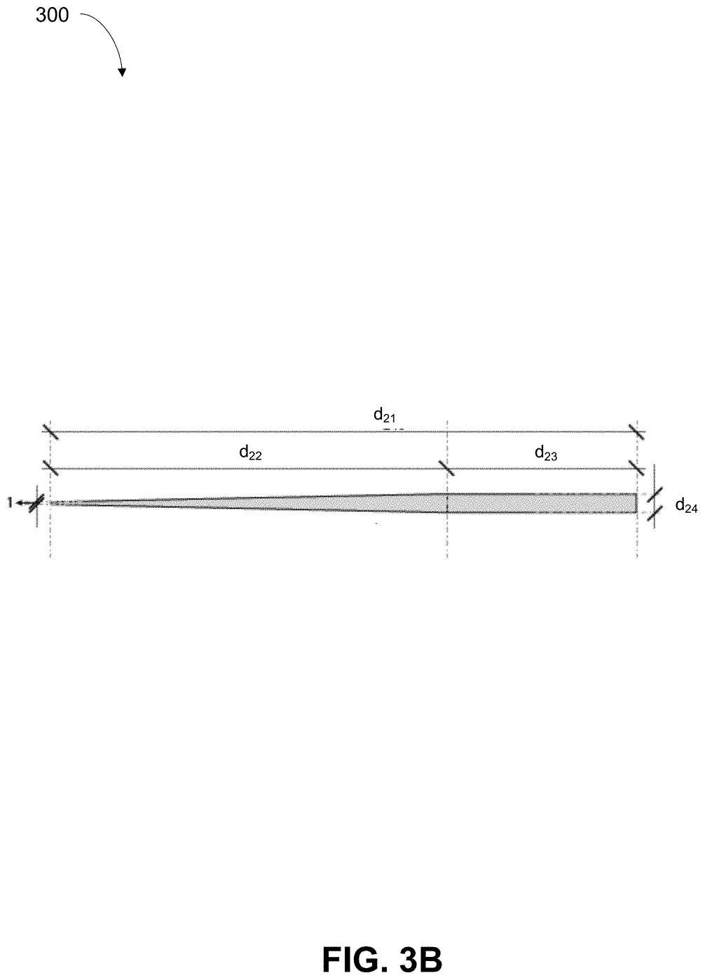

Referring to FIG. 3A-FIG. 3B, an edible chopstick 300 is depicted. The edible chopstick 300 may have a first end 302 disposed opposite a second end 304 and a body portion 306 disposed between the first end 302 and the second end 304. The second end 304 of the edible chopstick 300 may be pointed. The body portion 306 may be long and narrow in shape. A user may utilize a pair of the edible chopsticks 300 when consuming a food product. Various dimensions for the edible chopstick 300 are provided in Table 4.

TABLE 4

| Dimension | Range (cm) | Range (mm) |
|---|---|---|
| d₂₁ | 240-242 | 2400-2420 |
| d₂₂ | 158-160 | 1580-1600 |
| d₂₃ | 80-82 | 800-820 |
| d₂₄ | 7-9 | 70-90 |

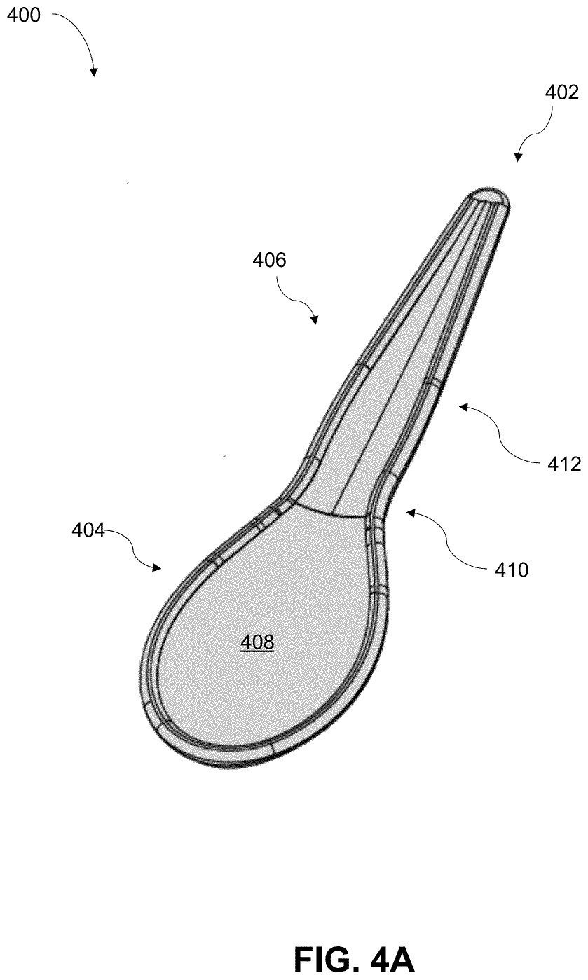

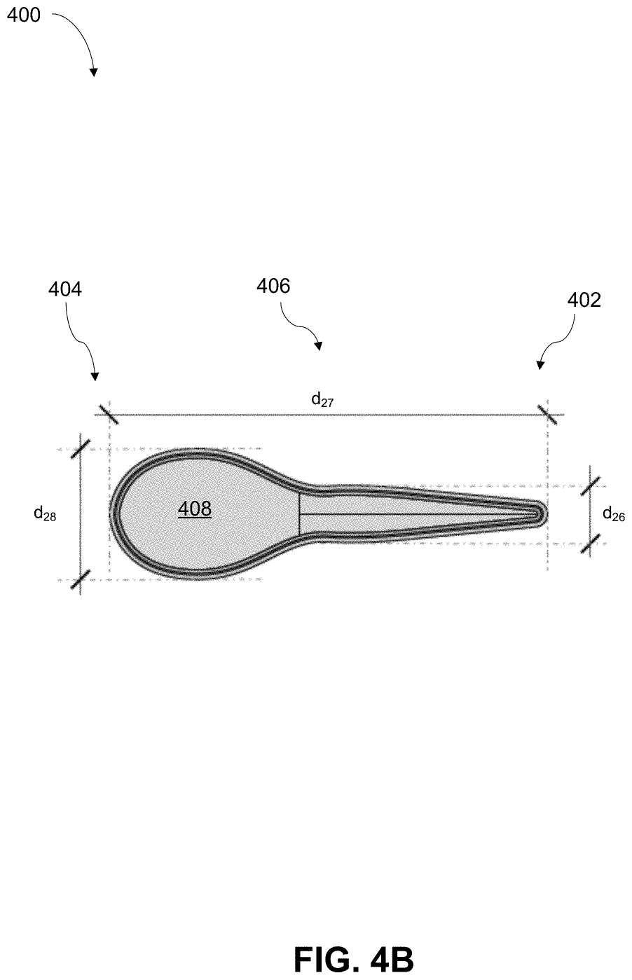

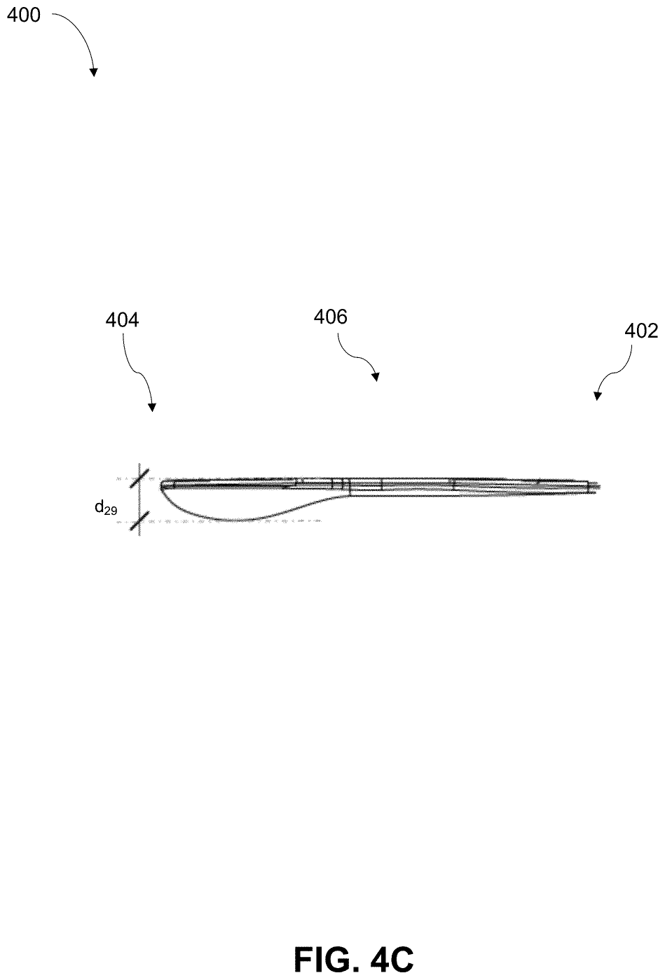

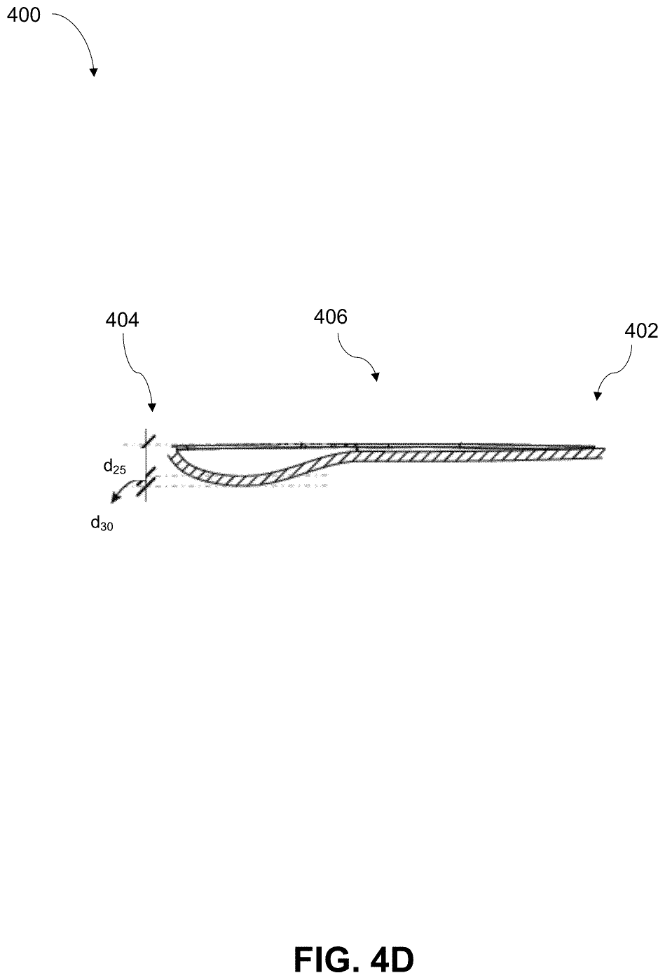

Referring to FIG. 4A, FIG. 4B, FIG. 4C, and FIG. 4D, an edible tablespoon 400 is depicted. The edible tablespoon 400 has a first end 402 disposed opposite a second end 404 and a body portion 406 disposed between the first end 402 and the second end 404. The body portion 406 (e.g., a handle portion) of the edible tablespoon 400 is substantially planar in shape and may have slight curvature 412. Moreover, the second end 404 of the edible tablespoon 400 comprises a concave portion 408. Such concave portion 408 is a shallow oval or round bowl portion used for scooping, eating, and/or stirring food. The concave portion 408 is affixed to the body portion 406 at a location 410. Various dimensions for the edible tablespoon 400 are provided in Table 5.

TABLE 5

| Dimension | Range (cm) | Range (mm) |
|---|---|---|
| d₂₅ | 8-10 | 80-100 |
| d₂₆ | 18-20 | 180-200 |
| d₂₇ | 134-136 | 1340-1360 |
| d₂₈ | 39-41 | 390-410 |
| d₂₉ | 12-14 | 120-140 |
| d₃₀ | 2-4 | 20-40 |

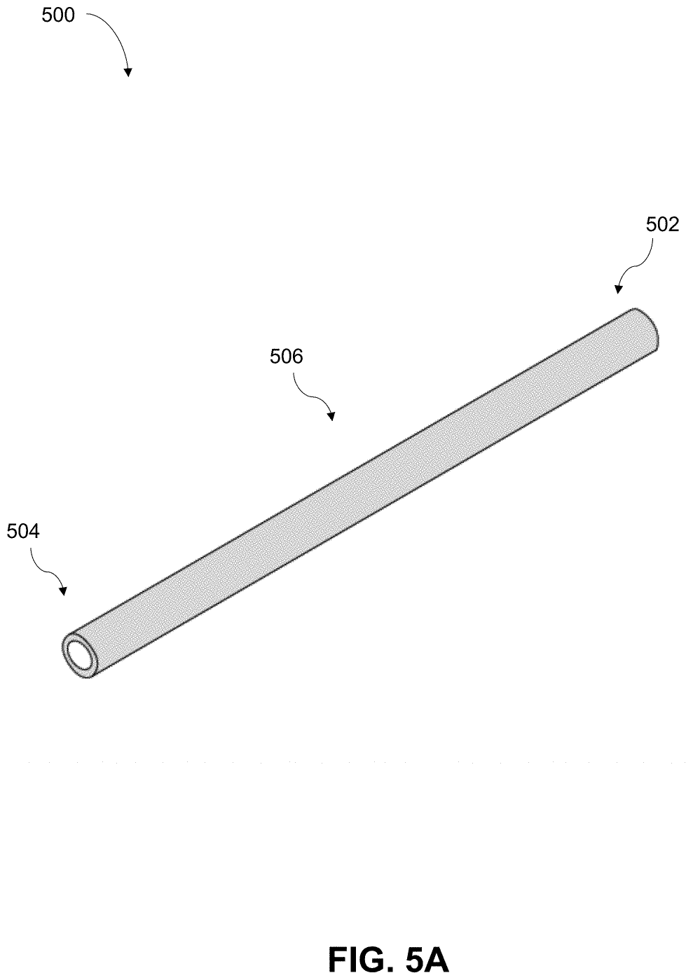

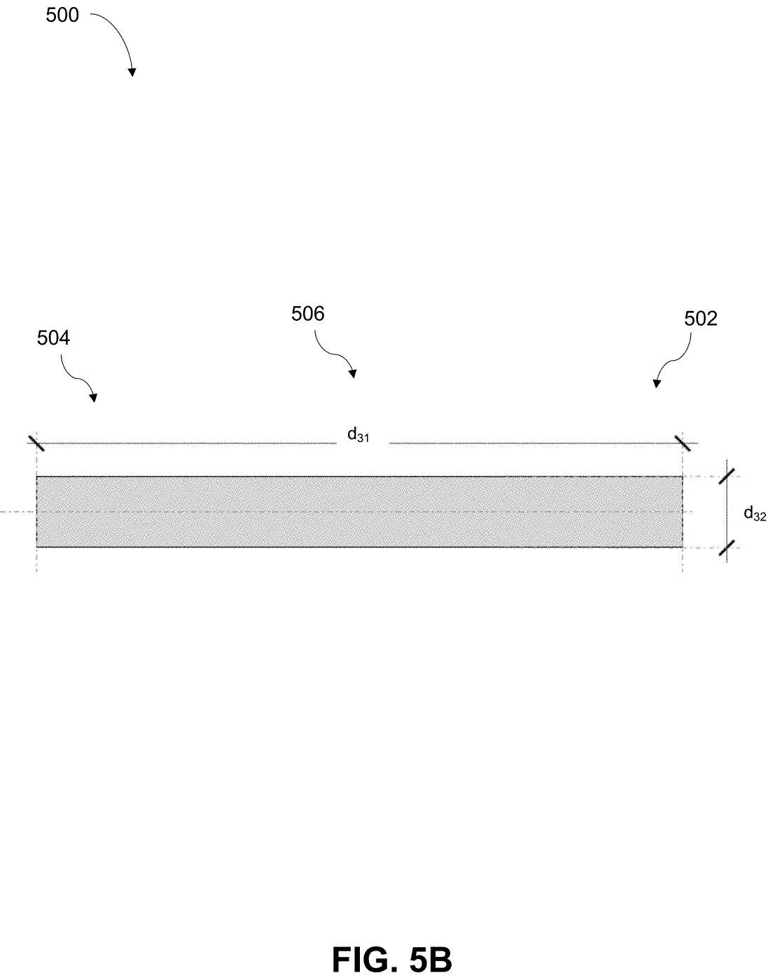

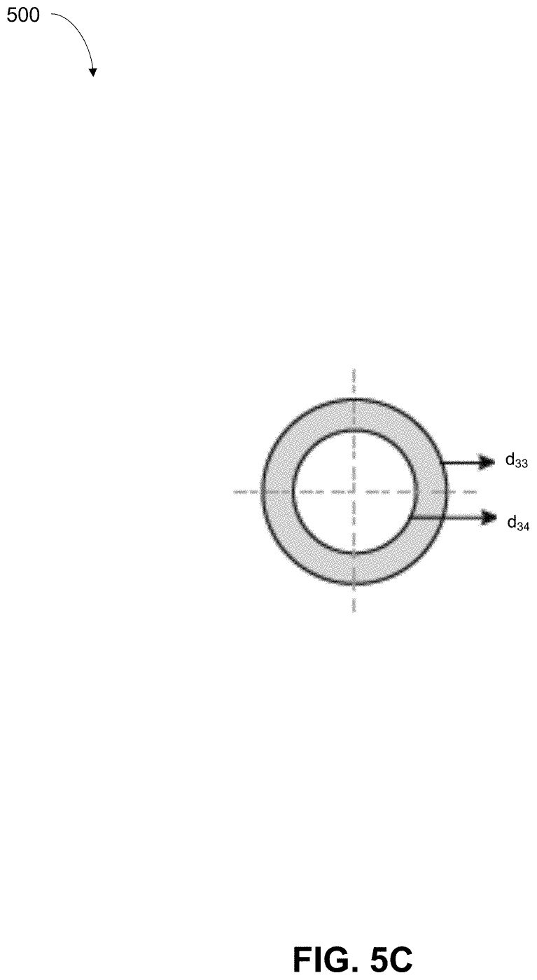

Referring to FIG. 5A, FIG. 5B, and FIG. 5C, an edible straw 500 is depicted. The edible straw 500 comprises a first end 502 disposed opposite a second end 504 and a body portion 506 disposed between the first end 502 and the second end 504. The body portion 506 of the edible straw 500 comprises an opening spanning a length of the body portion 506. The user places the first end 502 of the edible stray 500 into a mouth of the user and the second end 504 of the edible stray 500 into a beverage to consume the beverage. Various dimensions for the edible straw 500 are provided in Table 6.

TABLE 6

| Dimension | Range (cm) | Range (mm) |
|---|---|---|
| d₃₁ | 198-200 | 1980-2000 |
| d₃₂ | 12-14 | 120-140 |
| d₃₃ | 12-14 | 120-140 |
| d₃₄ | 7-9 | 70-90 |

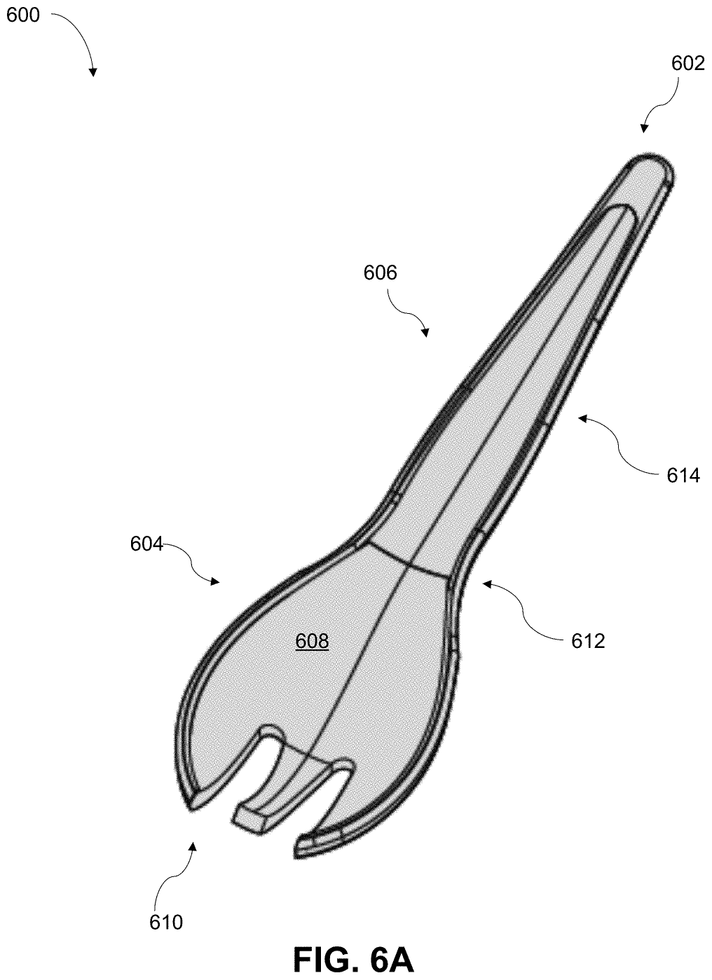

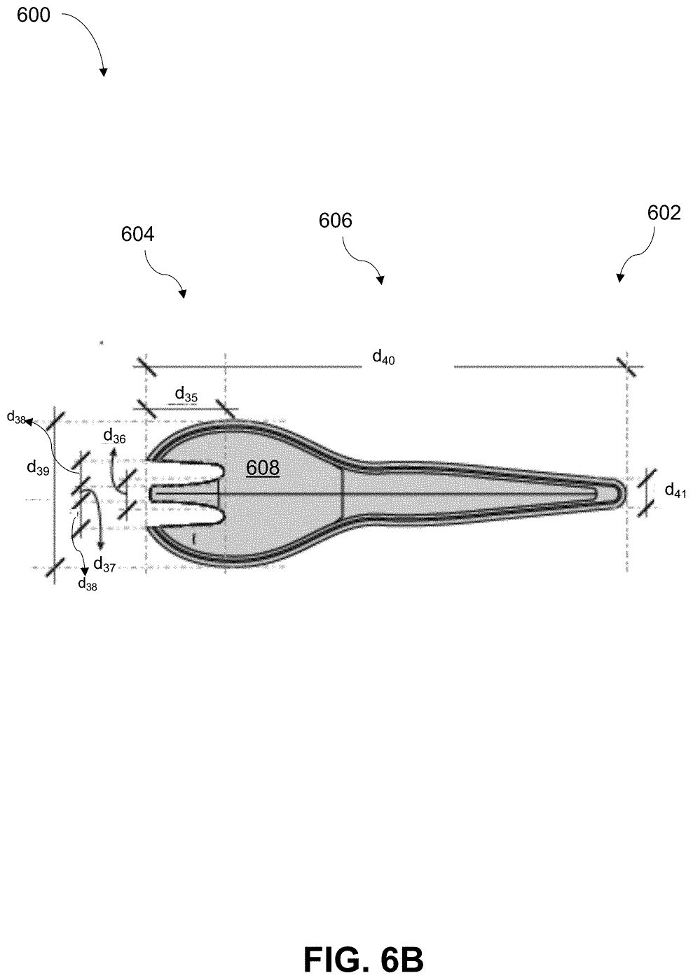

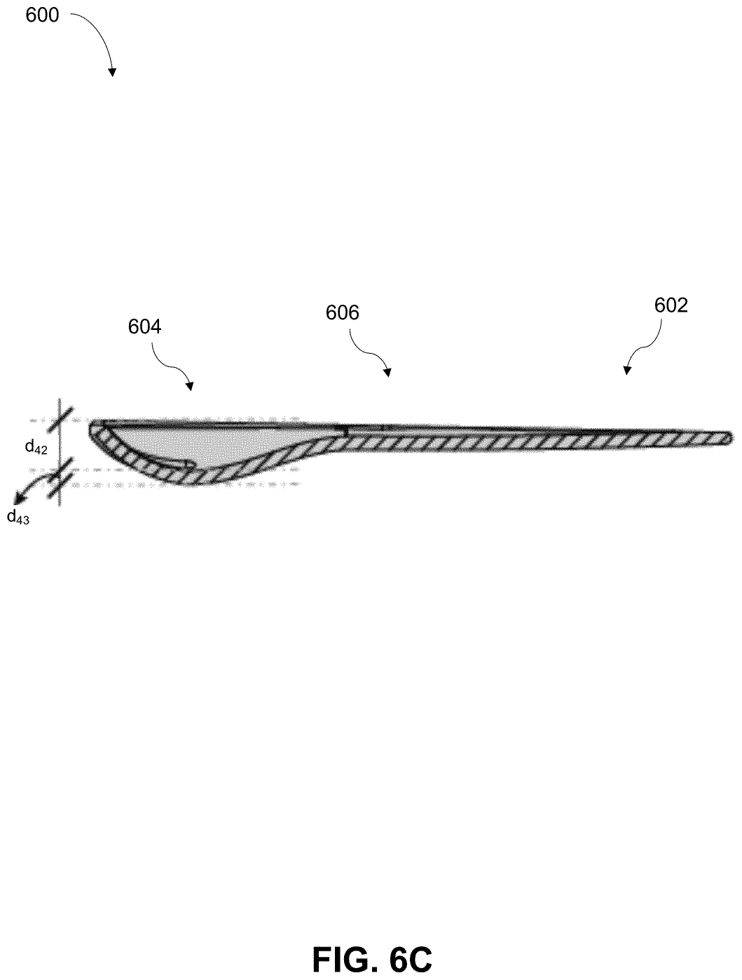

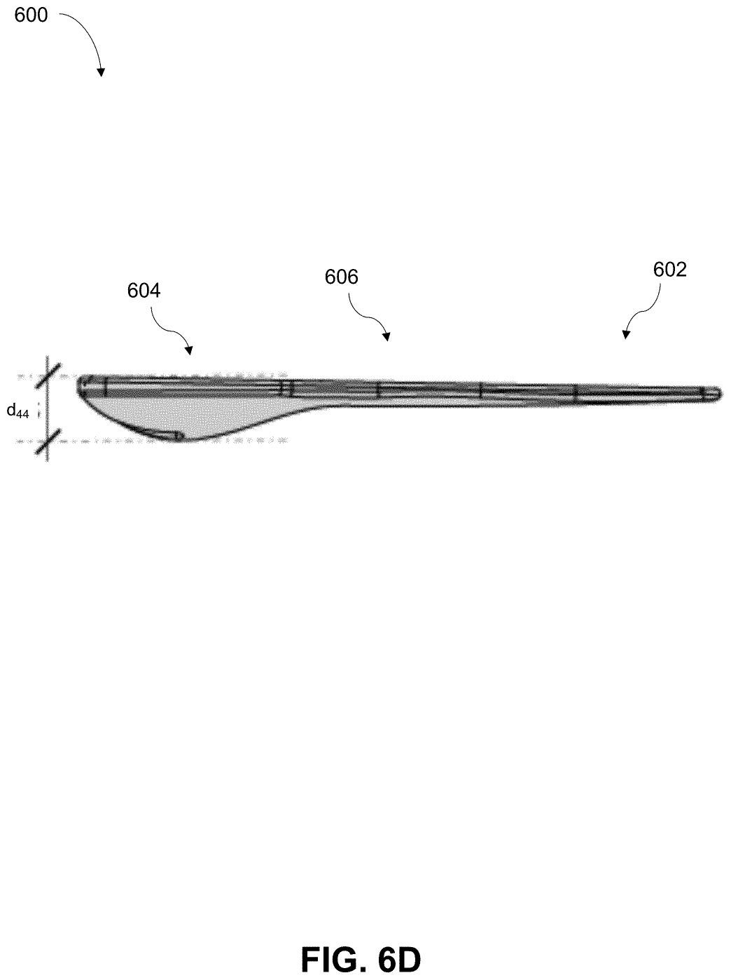

Referring to FIG. 6A, FIG. 6B, FIG. 6C, and FIG. 6D, an edible spork 600 is depicted. The edible spork 600 comprises a first end 602 disposed opposite a second end 604 and a body portion 606 disposed between the first end 602 and the second end 604. The body portion 606 may comprise a slight curvature 614. A concave portion 608 is located at the second end 604 of the edible spork 600. The concave portion 608 is affixed to the body portion 606 at a location 612. The concave portion 608 may comprise short tines 610 proximate the second end 604. Various dimensions for the edible spork 600 are provided in Table 7.

TABLE 7

| Dimension | Range (cm) | Range (mm) |
|---|---|---|
| d₃₅ | 20-23 | 200-230 |
| d₃₆ | 7-9 | 70-90 |
| d₃₇ | 4-6 | 40-60 |
| d₃₈ | 5-8 | 50-80 |
| d₃₉ | 39-41 | 390-410 |
| d₄₀ | 138-140 | 1380-1400 |
| d₄₁ | 6-9 | 60-90 |
| d₄₂ | 9-11 | 90-110 |
| d₄₃ | 2-4 | 20-40 |
| d₄₄ | 12-14 | 120-140 |

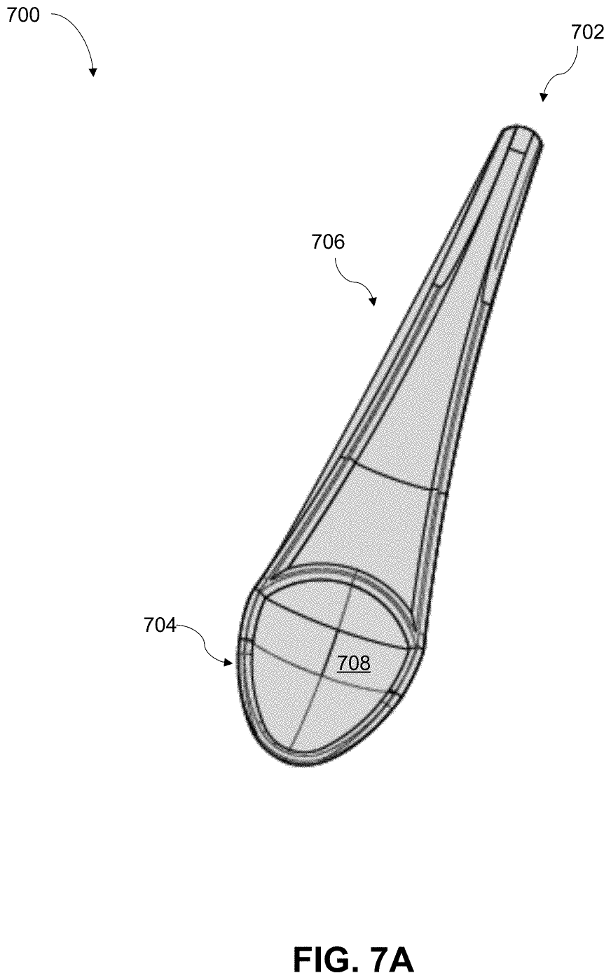

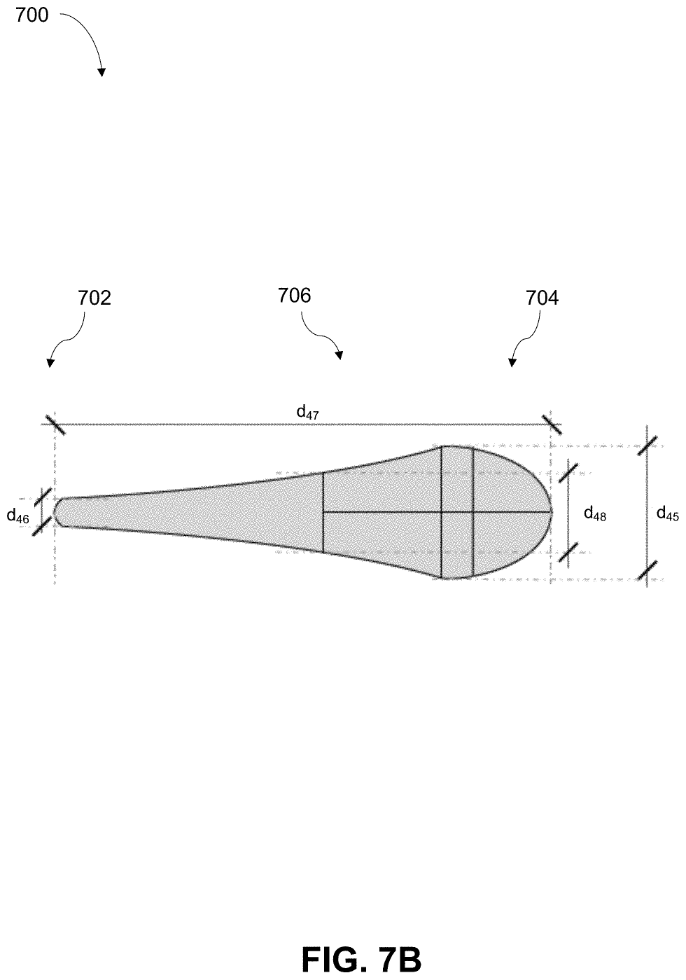

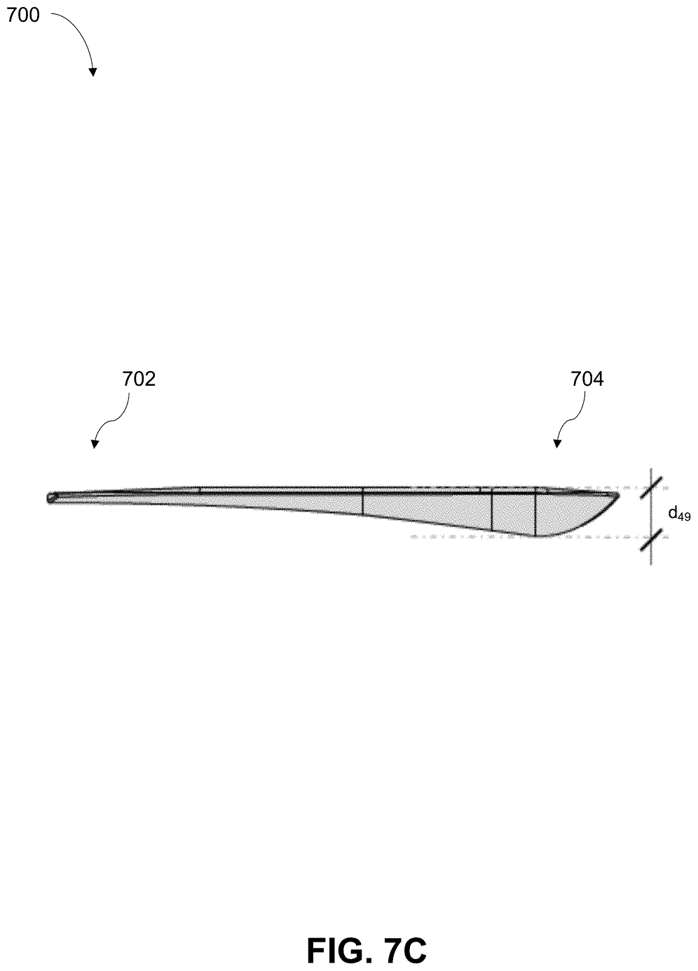

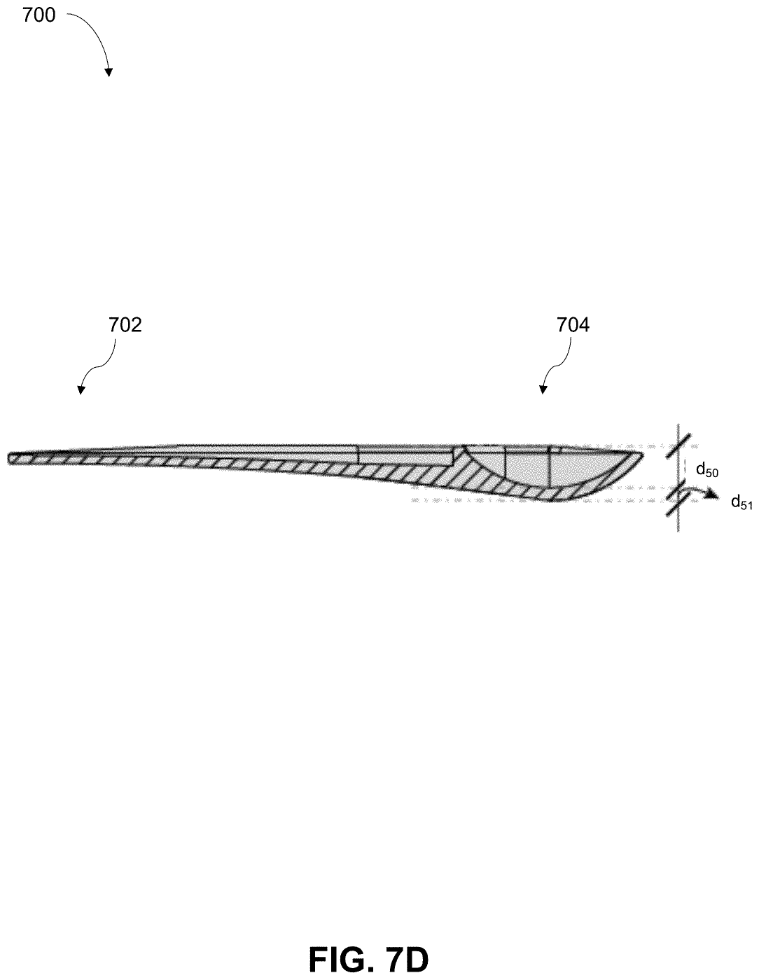

Referring to FIG. 7A, FIG. 7B, FIG. 7C, and FIG. 7D, an edible angled spoon 700 is depicted. The edible angled spoon 700 has a first end 702 disposed opposite a second end 704 and a body portion 706 disposed between the first end 702 and the second end 704. The body portion 706 may be a handle portion gripped by the user. The second end 704 may comprise a concave portion 708 used for scooping, eating, and/or stirring food. Various dimensions for the edible angled spoon 700 are provided in Table 8.

TABLE 8

| Dimension | Range (cm) | Range (mm) |
|---|---|---|
| d₄₅ | 32-35 | 320-350 |
| d₄₆ | 7-9 | 70-90 |
| d₄₇ | 130-133 | 1300-1330 |
| d₄₈ | 20-22 | 200-220 |
| d₄₉ | 10-12 | 100-120 |
| d₅₀ | 7-9 | 70-90 |
| d₅₁ | 2-4 | 20-40 |

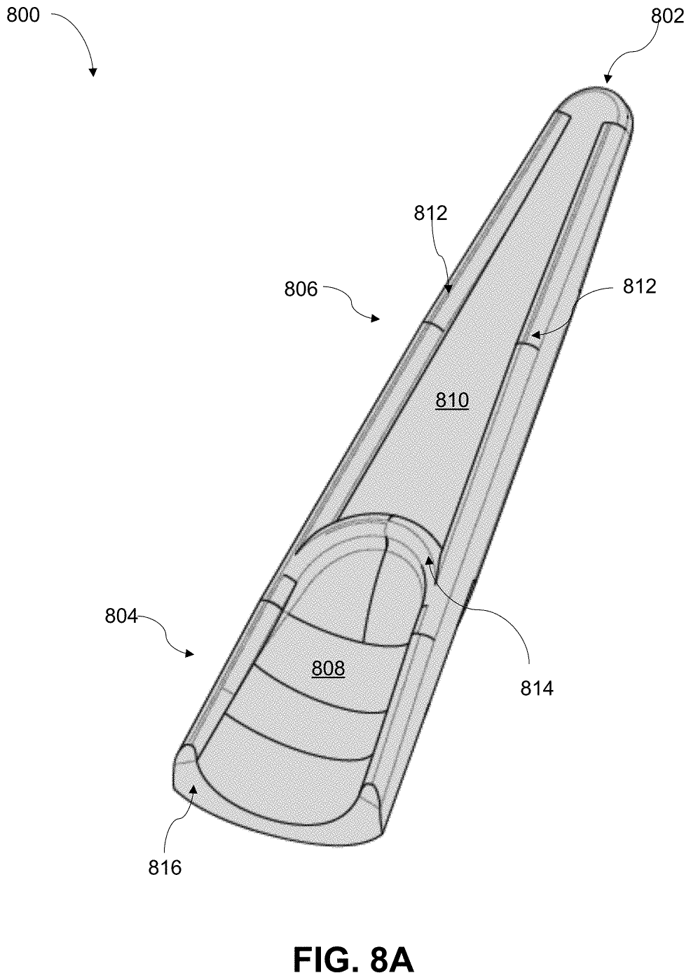

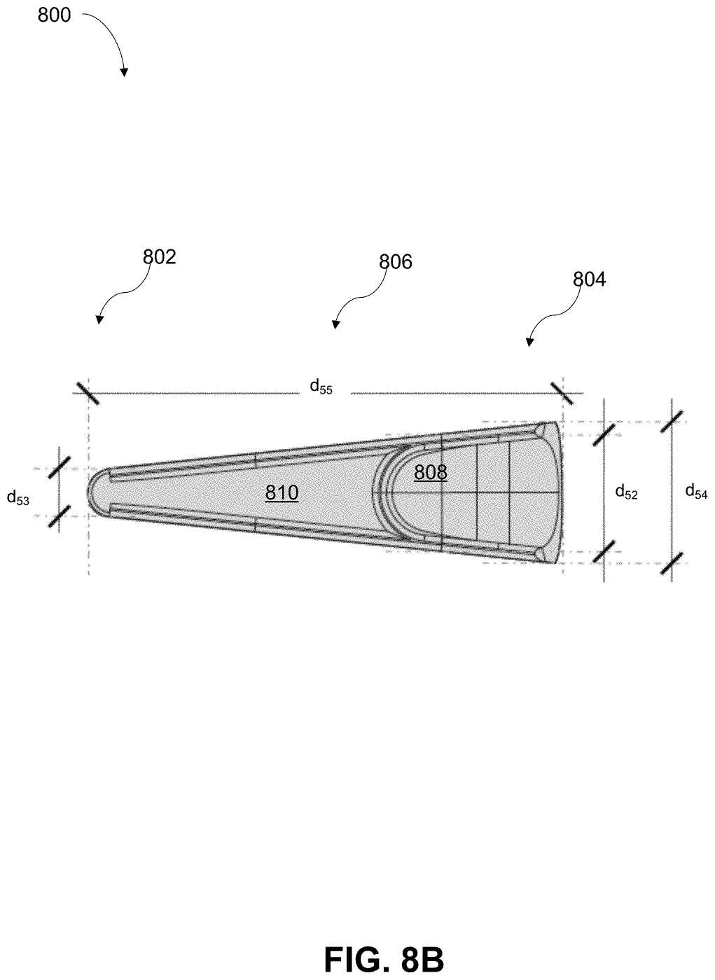

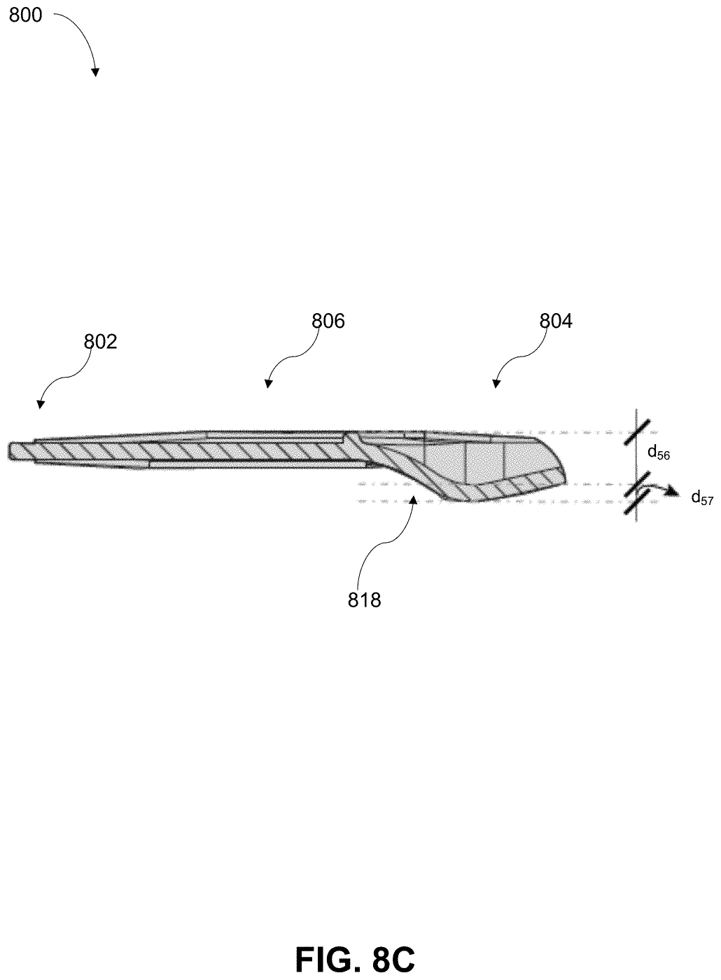

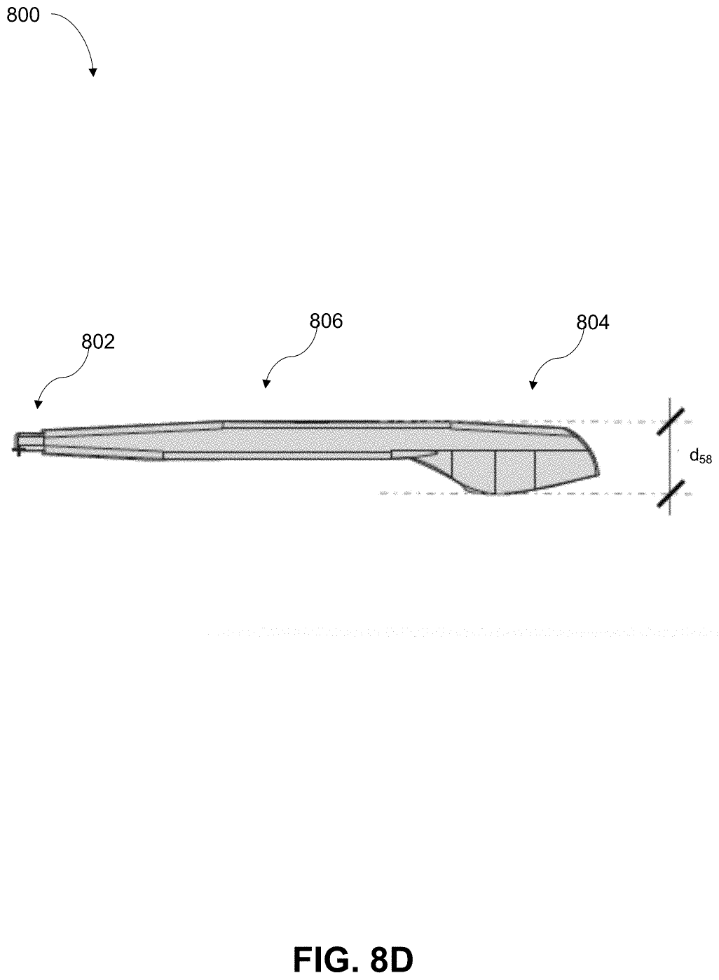

Referring to FIG. 8A, FIG. 8B, FIG. 8C, and FIG. 8D, a first embodiment of an edible ice cream scoop 800 is depicted. The first embodiment of the edible ice cream scoop 800 has a first end 802 disposed opposite a second end 804 and a body portion 806 disposed between the first end 802 and the second end 804. The body portion 806 of the first embodiment of the edible ice cream scoop 800 may be a handle portion gripped by the user.

In some examples and as depicted, the body portion 806 may be a planar component having a recess 810 disposed between two edges 812 extending from a periphery of the recess 810 of the body portion 806. The second end 704 may comprise a concave portion 808 used for scooping ice cream or other food products. The concave portion 808 may be affixed to the body portion 806 at a location 814, which may be semi-circular in shape. The concave portion 808 may comprise a u-shaped portion 816 proximate the second end 804 of the first embodiment of the edible ice cream scoop 800. Various dimensions for the first embodiment of the edible ice cream scoop 800 are provided in Table 9.

TABLE 9

| Dimension | Range (cm) | Range (mm) |
|---|---|---|
| d₅₂ | 23-25 | 230-250 |
| d₅₃ | 8-10 | 80-100 |
| d₅₄ | 28-30 | 280-300 |
| d₅₅ | 99-101 | 990-1010 |
| d₅₆ | 8-10 | 80-100 |
| d₅₇ | 2-4 | 20-40 |
| d₅₈ | 11-13 | 110-130 |

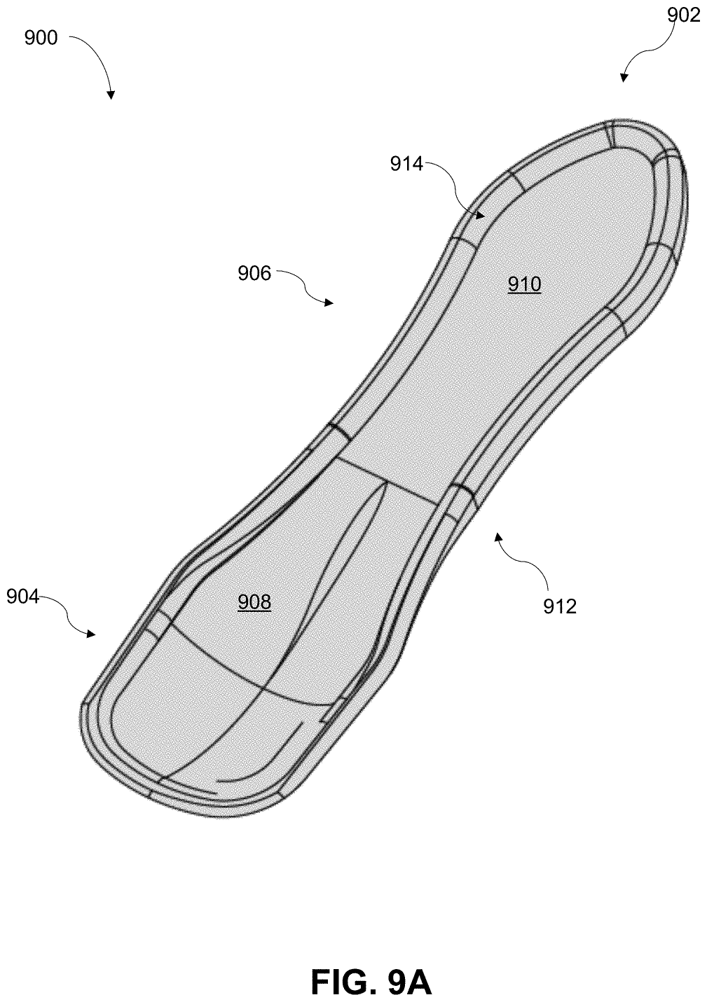

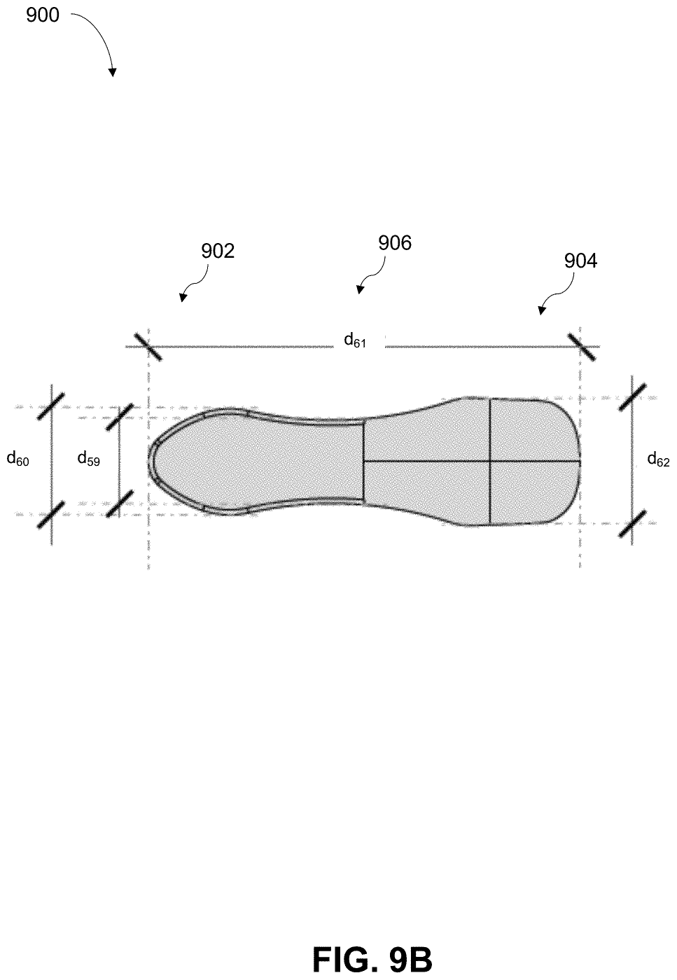

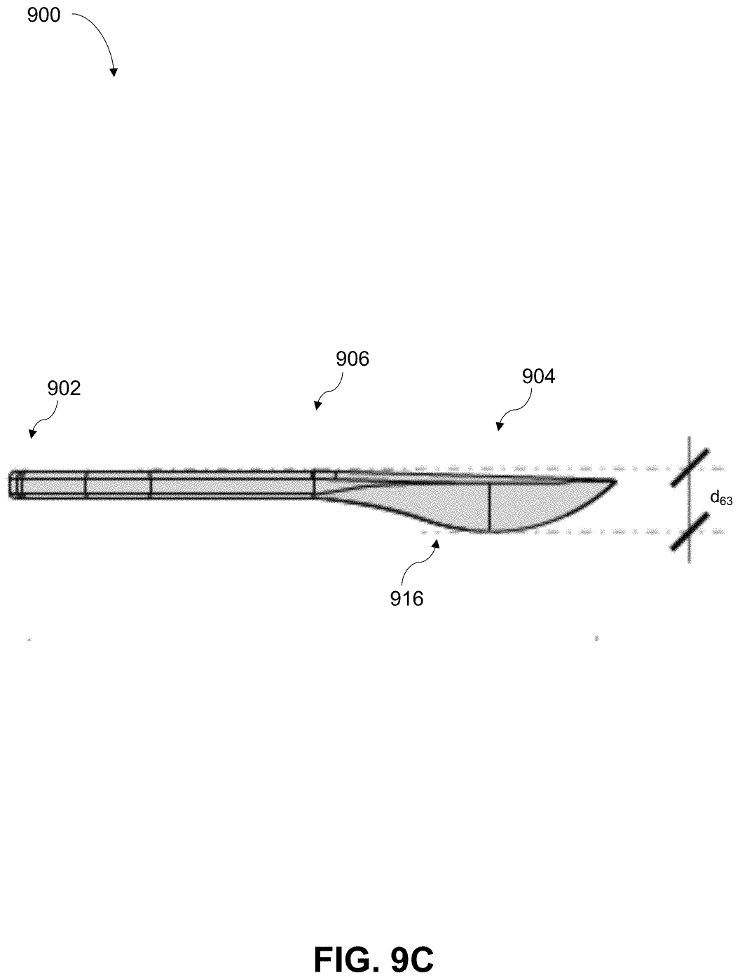

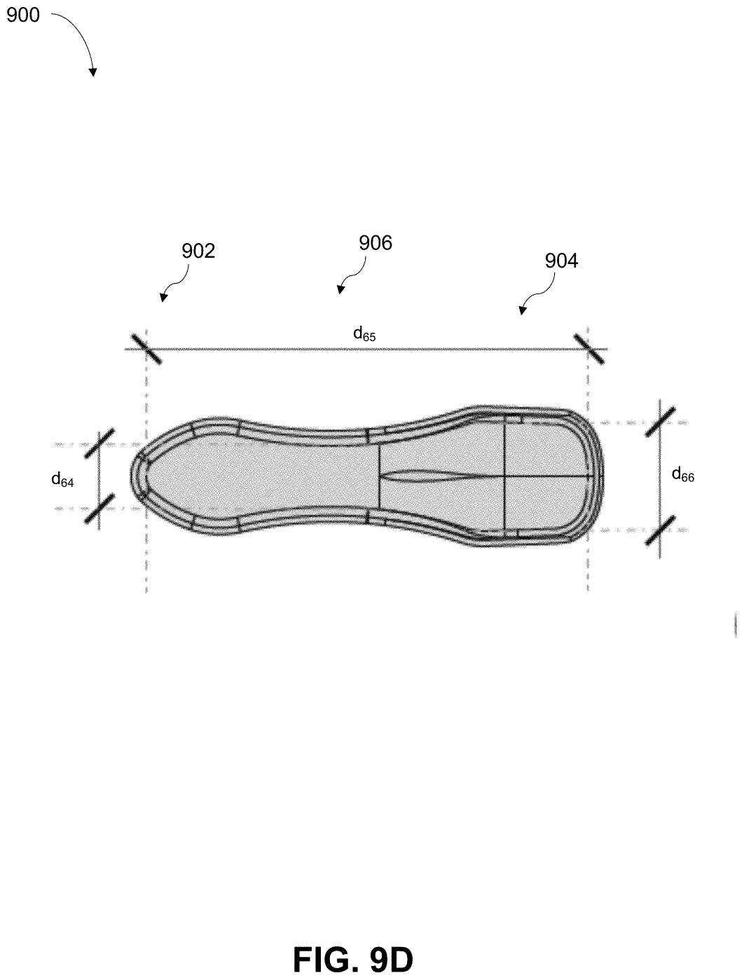

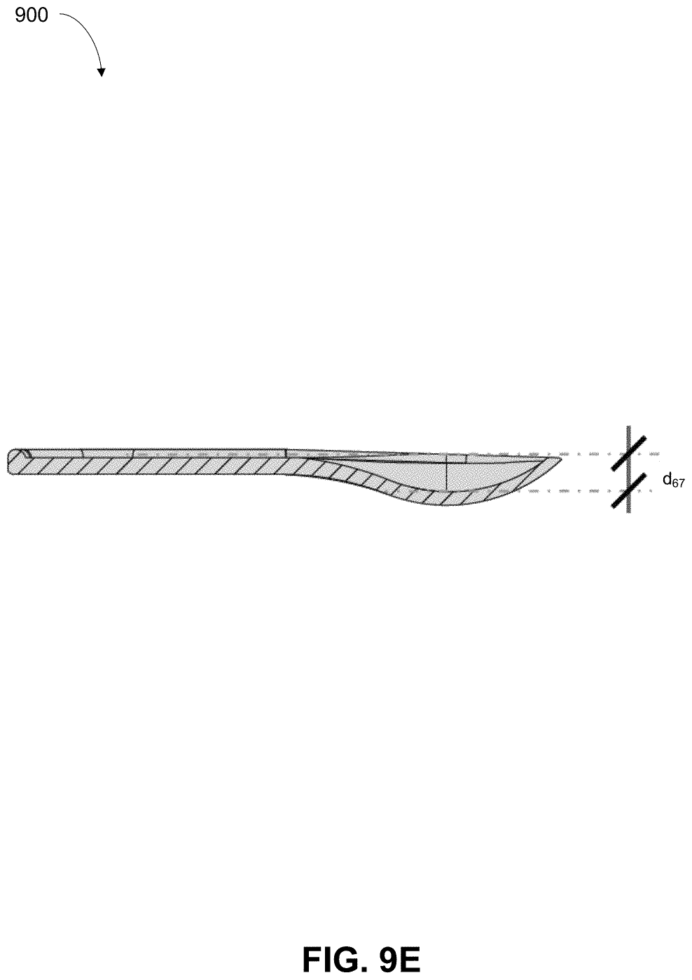

Referring to FIG. 9A, FIG. 9B, FIG. 9C, and FIG. 9D, a second embodiment of an edible ice cream scoop 900 is depicted. The second embodiment of the edible ice cream scoop 900 has a first end 902 disposed opposite a second end 904 and a body portion 906 disposed between the first end 902 and the second end 904. The body portion 906 of the second embodiment of the edible ice cream scoop 900 may be a handle portion gripped by the user.

In some examples and as depicted, the body portion 906 may be a planar component having a recess 910 disposed between edges 914. The edges 914 may be located about and extend from a periphery of the recess 910. The second end 904 may comprise a concave portion 908 used for scooping ice cream or another food. The concave portion 908 may be affixed to the body portion 906 at a location 912. Various dimensions for the first embodiment of the edible ice cream scoop 900 are provided in Table 10.

TABLE 10

| Dimension | Range (cm) | Range (mm) |
|---|---|---|
| d₅₉ | 18-20 | 180-200 |
| d₆₀ | 23-25 | 230-250 |
| d₆₁ | 98-100 | 980-1000 |
| d₆₂ | 28-30 | 280-300 |
| d₆₃ | 9-11 | 90-110 |
| d₆₄ | 12-14 | 120-140 |
| d₆₅ | 92-94 | 920-940 |
| d₆₆ | 21-23 | 210-230 |
| d₆₇ | 6-8 | 60-80 |

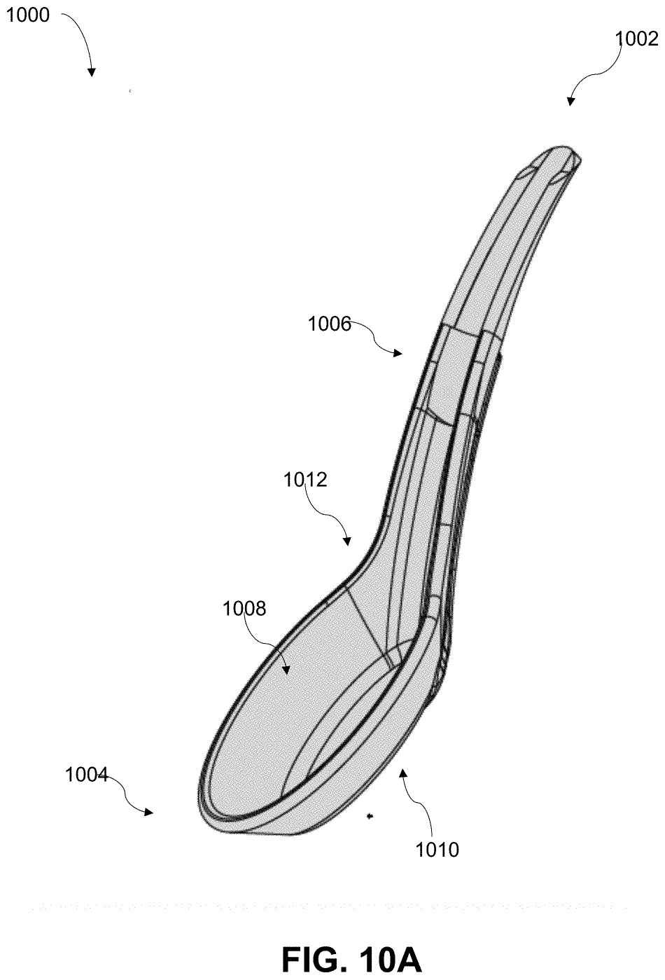

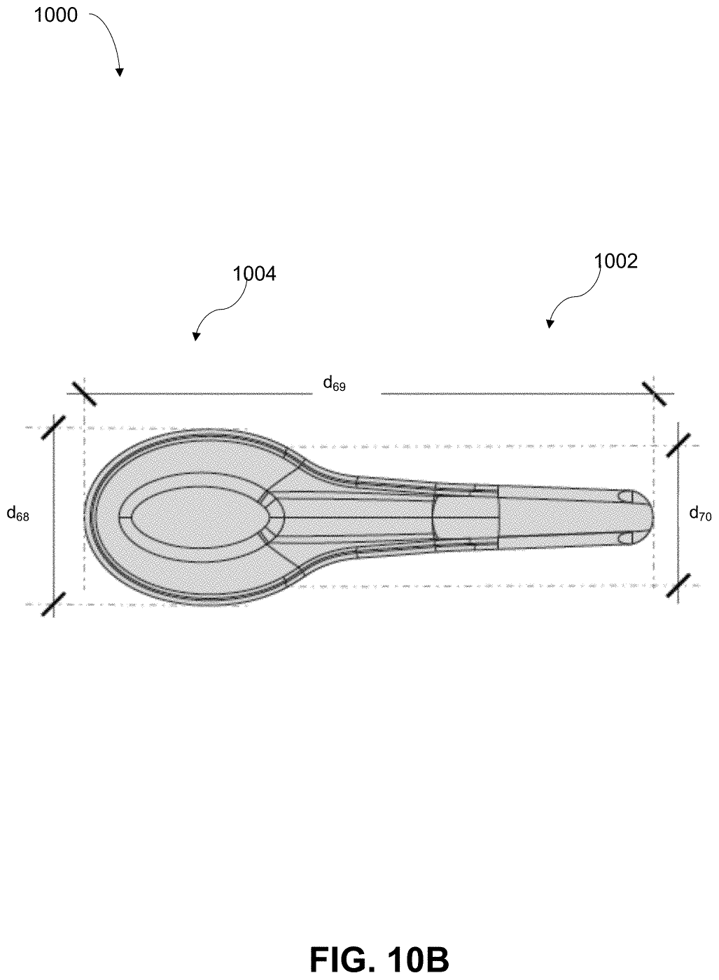

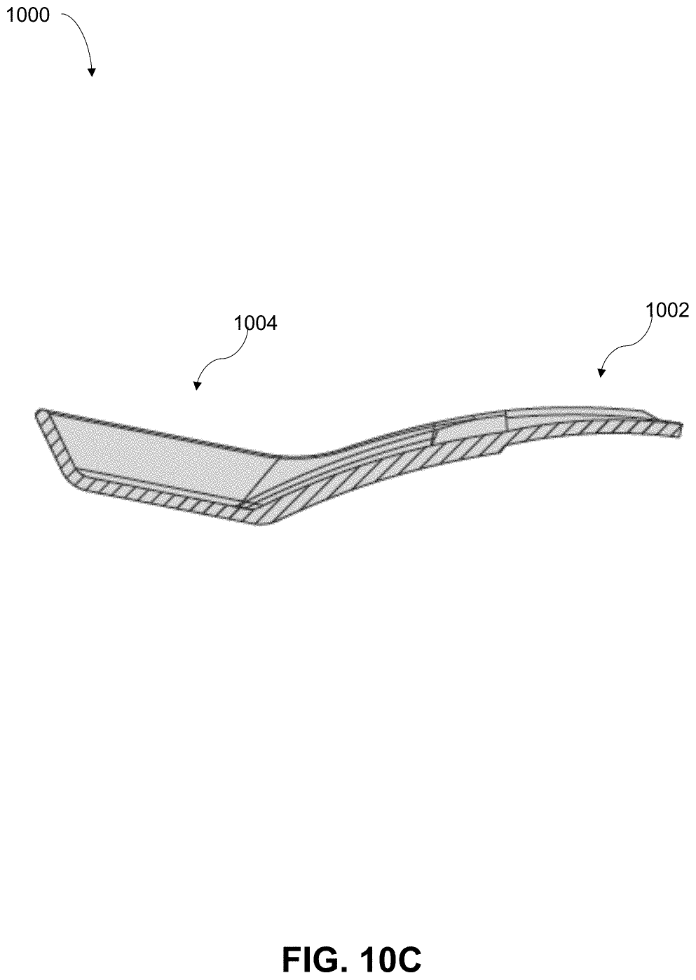

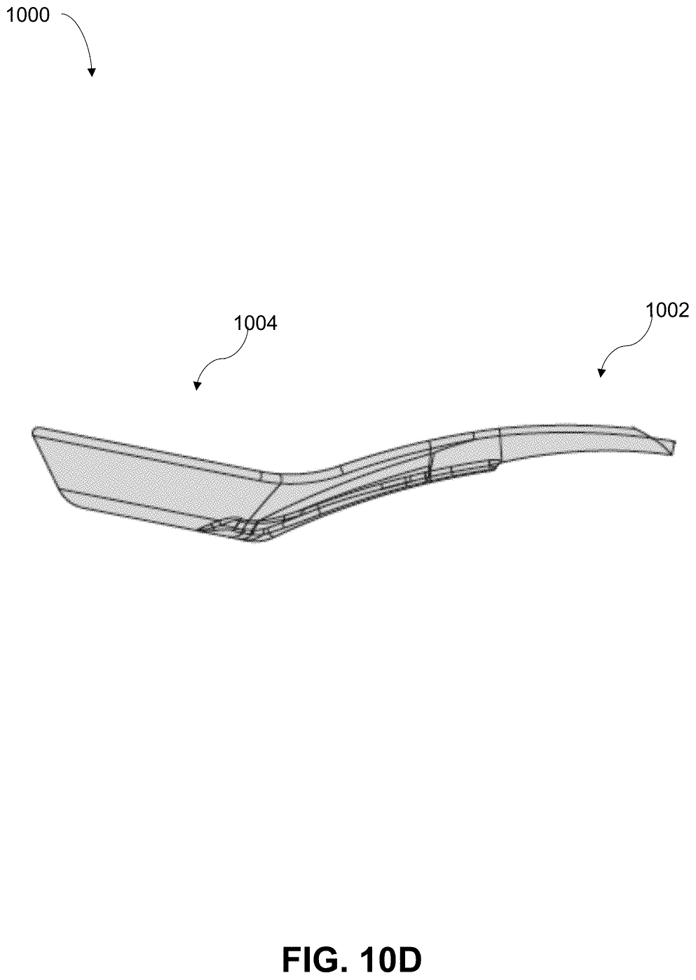

Referring to FIG. 10A, FIG. 10B, FIG. 10C, and FIG. 10D, an edible soup spoon 1000 is depicted. The edible soup spoon 1000 has a first end 1002 disposed opposite a second end 1004 and a body portion 1006 disposed between the first end 1002 and the second end 1004. The body portion 1006 may be a handle portion gripped by the user. A concave portion may be present at the second end 1004 of the edible soup spoon 1000. The concave portion may include a planar portion 1010 and an edge 1008 that extends around a periphery of the planar portion 1010 and away from the planar portion 1010. The concave portion is affixed to the body portion 1006 at a location 1012. Various dimensions for the edible soup spoon 1000 are provided in Table 11.

TABLE 11

| Dimension | Range (cm) | Range (mm) |
|---|---|---|
| d₆₈ | 43-45 | 430-450 |
| d₆₉ | 144-146 | 1440-1460 |
| d₇₀ | 34-36 | 340-360 |

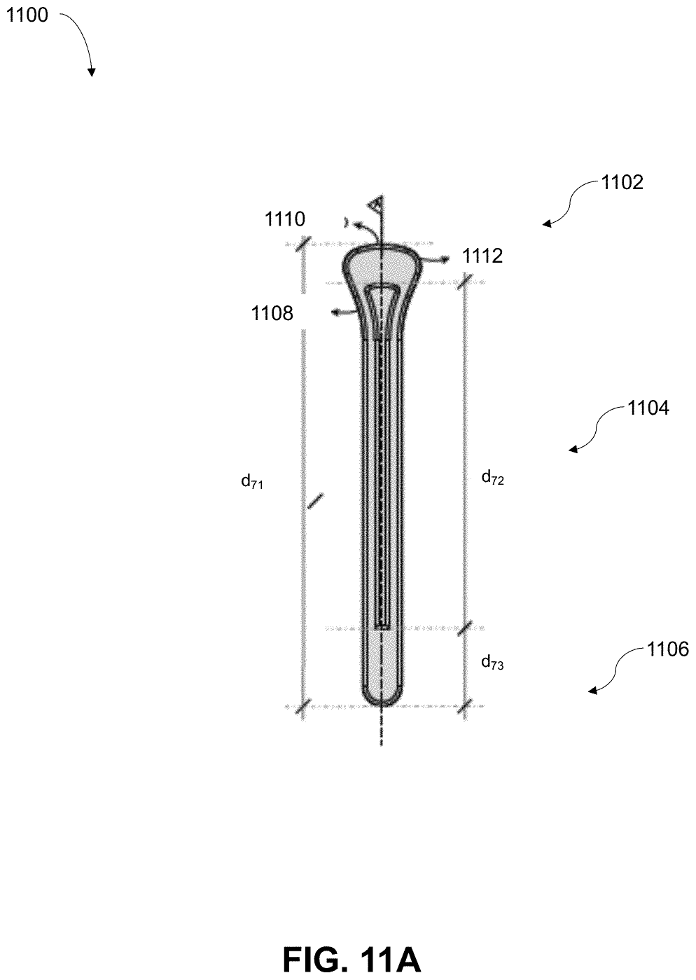

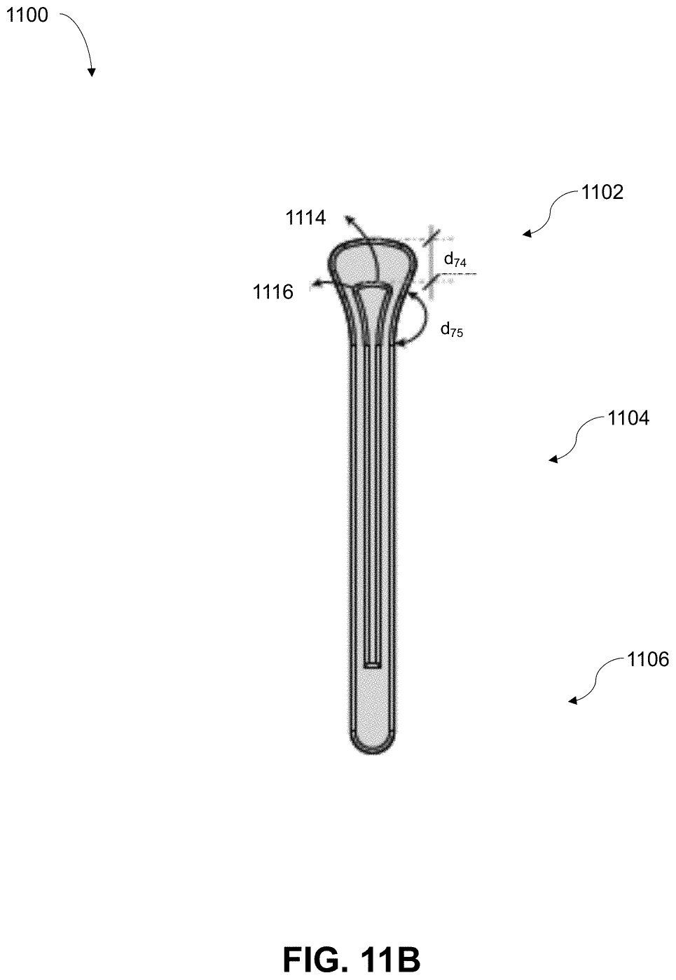

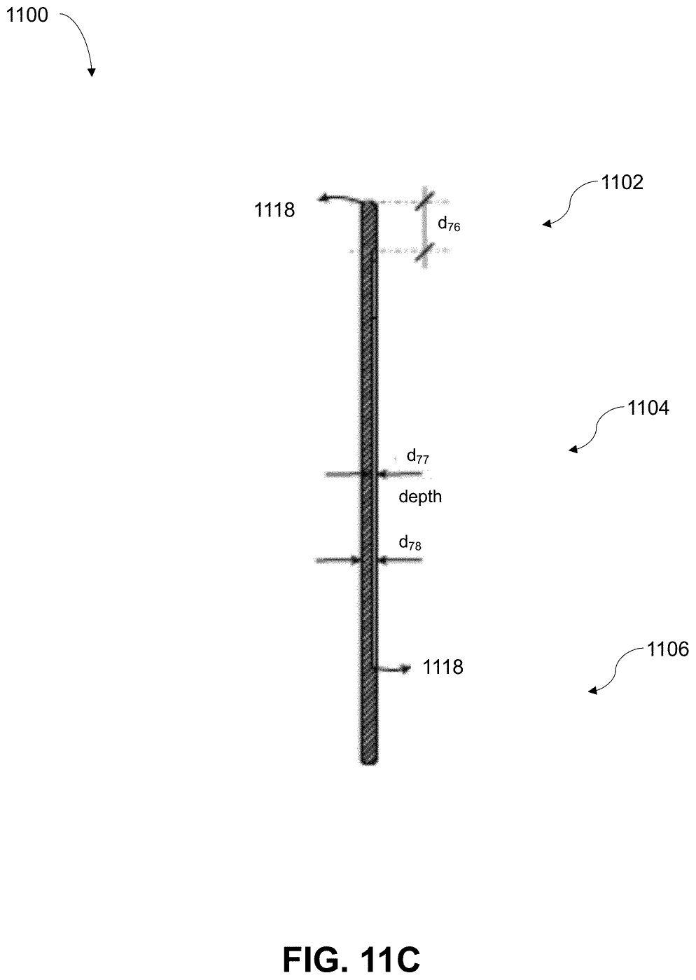

Referring to FIG. 11A, FIG. 11B, and FIG. 11C, an edible drink stick 1100 is depicted. The edible drink stick 1100 may be an edible coffee stick, in examples. However, it should be appreciated that the edible drink stick 1100 may be used with any beverage. The edible drink stick 1100 includes a first end 1102 disposed opposite a second end 1106. A body portion 1104 is disposed between the first end 1102 and the second end 1106.

The edible drink stick 1100 is substantially planar in shape. A protruding portion 1112 is present at the first end 1102 of the edible drink stick 1100. Moreover, the protruding portion 1112 is affixed to the body portion 1104 at a location 1108 and extends from the body portion 1104 to another location 1110. Various dimensions for the edible drink stick 1100 are provided in Table 12, Table 13, and Table 14.

TABLE 12

| Dimension | Range (cm) | Range (mm) |
|---|---|---|
| d₇₁ | 119-121 | 1190-1210 |
| d₇₂ | 89-91 | 890-910 |
| d₇₃ | 19-21 | 190-210 |
| d₇₆ | 9-11 | 90-110 |

TABLE 13

| Dimension | Measurement Range (mm) | |
|---|---|---|
| d₇₄ | 8-10 | mm offset |
| d₇₇ | 1-2 | mm depth |
| d₇₈ | 2-4 | mm |

TABLE 14

| Dimension | Measurement Range (Degrees) |
|---|---|
| d₇₅ | 156-158 |

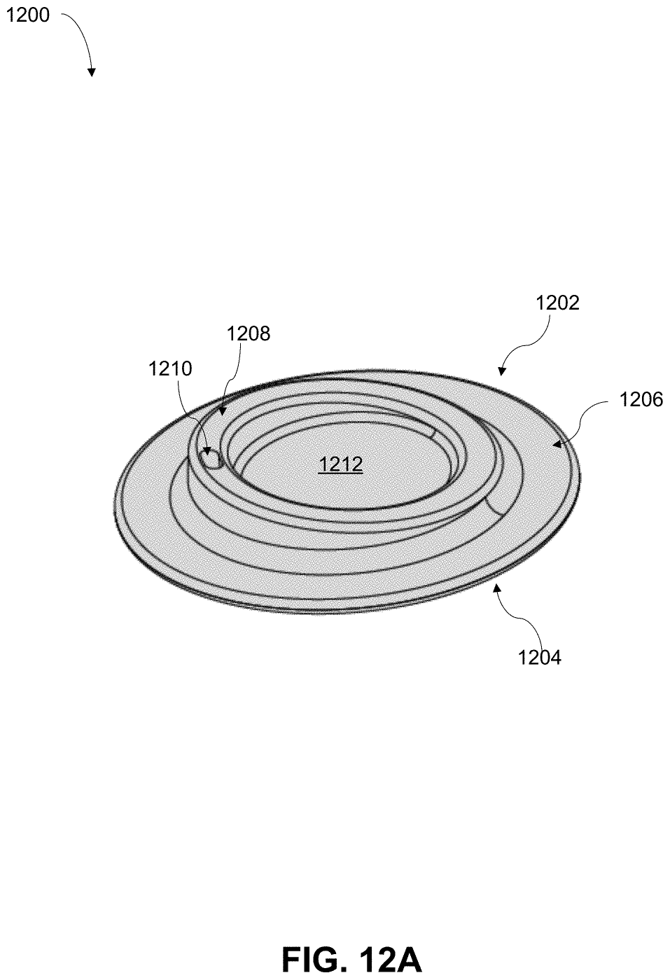

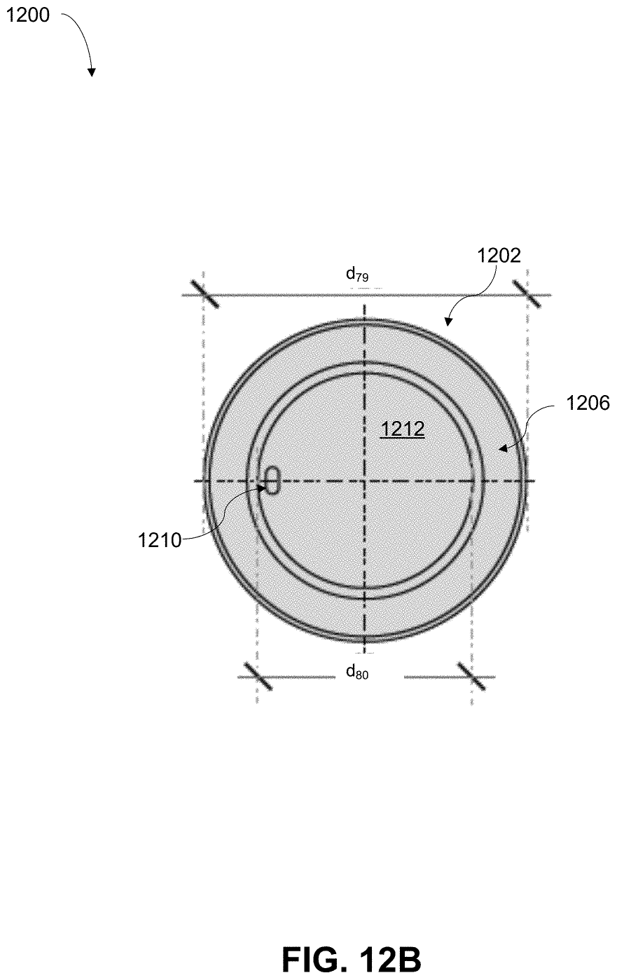

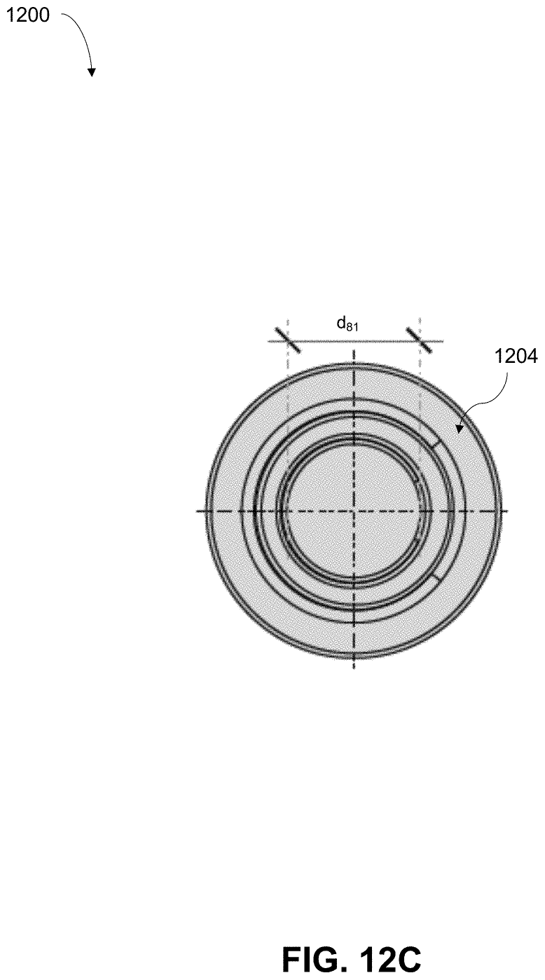

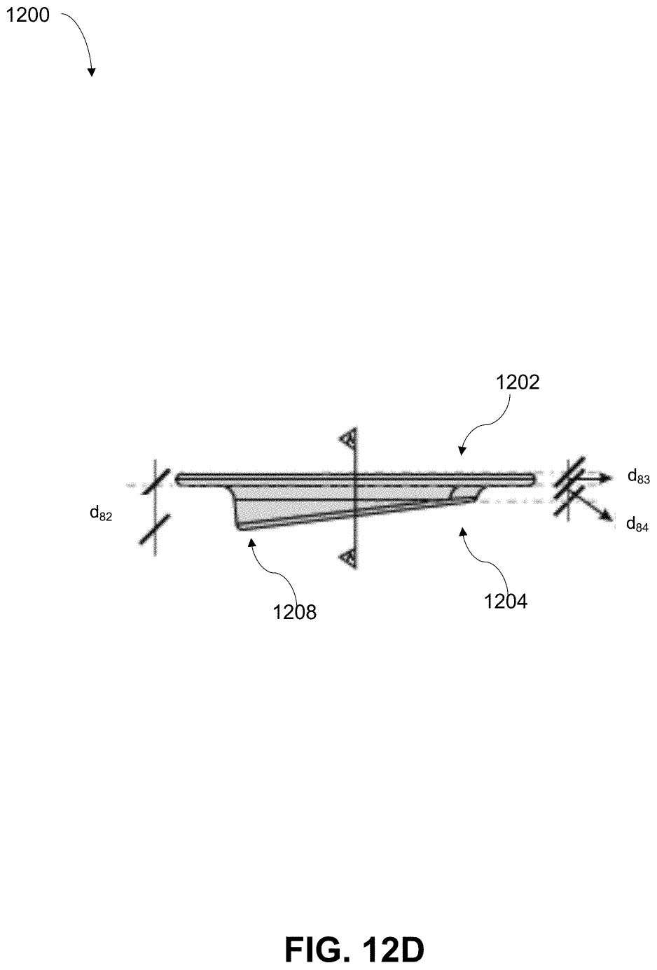

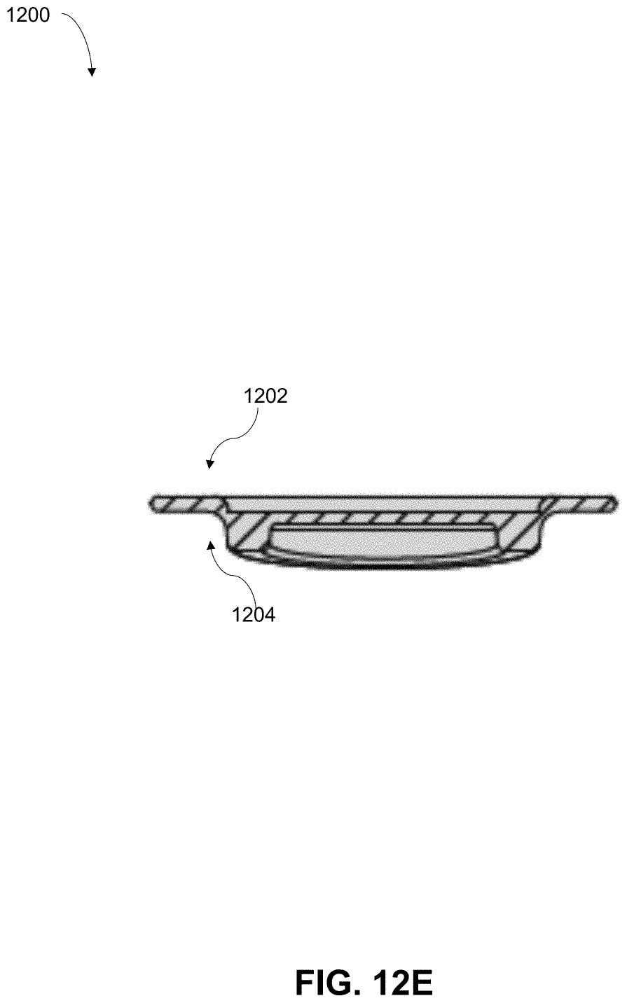

Referring to FIG. 12A, FIG. 12B, FIG. 12C, FIG. 12D, and FIG. 12E, an edible drink cap 1200 is depicted. In examples, the edible drink cap 1200 may be an edible coffee cap/lid. However, the edible drink cap 1200 is not limited to such. As shown, the edible drink cap 1200 has a substantially planar portion 1202, having a first side 1206 disposed opposite a second side 1204. The first side 1206 comes in contact with a cup.

A portion 1208 is located substantially in the center of and extends away from the first side 1206 of the edible drink cap 1200. Another portion 1212 is located within the portion 1208. Moreover, the portion 1208 extends away from the first side 1206 of the edible drink cap 1200 in a slanted configuration, where a portion of the portion 1208 extends further away from the first side 1206 of the edible drink cap 1200 than another portion. At a greatest distance from the first side 1206 of the edible drink cap 1200, the portion 1208 comprises an opening 1210. The opening 1210 allows the user to consume a beverage therethrough when the first side 1206 is affixed to the cup.

Various dimensions for the edible drink cap 1200 are provided in Table 15.

TABLE 15

| Dimension | Range (cm) | Range (mm) |
|---|---|---|
| d₇₉ | 119-121 | 1190-1210 |
| d₈₀ | 79-81 | 790-810 |
| d₈₁ | 53-55 | 530-550 |
| d₈₂ | 13-15 | 130-150 |
| d₈₃ | 3-5 | 30-50 |
| d₈₄ | 4-6 | 40-60 |

The edible cutlery can comprise a smooth texture and/or a shiny appearance. The smooth texture can enable food to slide off of the edible cutlery without irritating a mouth of an operating while using the edible cutlery to eat food.

The edible cutlery as provided herein has a balanced strength in order to scoop out a small quantity of ice cream or any other cold dessert without breaking and can be soft enough to be eaten. In various examples, the edible cutlery can be used multiple times and stay firm till the food is consumed.

### EXAMPLES

Edible spoons were prepared with Formula F above in an edible tablespoon configuration of a first embodiment (e.g., the spoon 100 of FIG. 1A, FIG. 1B, FIG. 1C, FIG. 1D, and FIG. 1E) and an edible dessert spoon configuration of a second embodiment (e.g., the spoon 200 of FIG. 2A, FIG. 2B, FIG. 2C, FIG. 2D, and FIG. 2E). The edible spoons were evaluated in cold foods and hot foods. The evaluations were performed in an environment having a temperature of 72 degrees Fahrenheit.

The procedure for evaluating the edible spoons in hot foods was performed by bring water to a boil (e.g., 212 degree Fahrenheit) and removing the water from the heat. Thereafter, the edible spoons were placed in the hot water and a timer was started. Changes in the shape, strength, and hardness of the spoon were observed over 5 minutes intervals. At each interval, the edible spoon was lifted out of the water to evaluate the shape, strength, and hardness. It was observed that the head region of the edible tablespoons, based on mean average, would soften after 20 minutes in hot food testing (i.e., remain hard for at least 20 minutes in hot food testing) while the body region of the spoon would remain intact due to the support. It was observed that the head region of the edible dessert spoons, based on mean average, would soften after 25 minutes in hot food testing (i.e., remain hard for at least 25 minutes in hot food testing) while the body region of the spoon would remain intact due to the support.

The procedure for evaluating edible spoons in cold foods was performed by placing the spoons in ice cream having a temperature in a range of 6 degrees Fahrenheit to 10 degree Fahrenheit at the beginning of the test and starting a timer. Changes in the shape, strength, and hardness of the spoon were observed over 5 minutes intervals. It was observed that the head region of the edible tablespoons, based on mean average, would soften after 55 minutes in cold food testing (i.e., remain hard for at least 55 minutes in cold food testing) while the body region of the spoon would remain intact due to the support. It was observed that the head region of the edible dessert spoons, based on mean average, would soften after 100 minutes in cold food testing (i.e., remain hard for at least 100 minutes in cold food testing) while the body region of the spoon would remain intact due to the support.

The hot food and cold food testing procedures were each performed 10 times for each edible spoon configuration and the results shown in Table 16 are weight averages of the 10 trials.

TABLE 16

| | | Time to soften | Time to soften |
|---|---|---|---|
| | | (mean average, | (Range of samples |
| Spoon Configuration | Test | minutes) | tested, minutes) |
| Tablespoon | Hot Food | 20 | 15-25 |
| Dessert Spoon | Hot Food | 25 | 20-30 |
| Tablespoon | Cold Food | 55 | 45-75 |
| Dessert Spoon | Cold Food | 100 | 90-120 |

Those skilled in the art will recognize that the herein described compositions, articles, methods, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although various examples have been described herein, many modifications, variations, substitutions, changes, and equivalents to those examples may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed examples. The following claims are intended to cover all such modification and variations.

Various features and characteristics are described in this specification to provide an understanding of the composition, structure, production, function, and/or operation of the invention, which includes the disclosed compositions, coatings, and methods. It is understood that the various features and characteristics of the invention described in this specification can be combined in any suitable manner, regardless of whether such features and characteristics are expressly described in combination in this specification. The Inventors and the Applicant expressly intend such combinations of features and characteristics to be included within the scope of the invention described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

Any numerical range recited in this specification describes all sub-ranges of the same numerical precision (i.e., having the same number of specified digits) subsumed within the recited range. For example, a recited range of “1.0 to 10.0” describes all sub-ranges between (and including) the recited minimum value of 1.0 and the recited maximum value of 10.0, such as, for example, “2.4 to 7.6,” even if the range of “2.4 to 7.6” is not expressly recited in the text of the specification. Accordingly, the Applicant reserves the right to amend this specification, including the claims, to expressly recite any sub-range of the same numerical precision subsumed within the ranges expressly recited in this specification. All such ranges are inherently described in this specification such that amending to expressly recite any such sub-ranges will comply with the written description, sufficiency of description, and added matter requirements.

Also, unless expressly specified or otherwise required by context, all numerical parameters described in this specification (such as those expressing values, ranges, amounts, percentages, and the like) may be read as if prefaced by the word “about,” even if the word “about” does not expressly appear before a number. Additionally, numerical parameters described in this specification should be construed in light of the number of reported significant digits, numerical precision, and by applying ordinary rounding techniques. It is also understood that numerical parameters described in this specification will necessarily possess the inherent variability characteristic of the underlying measurement techniques used to determine the numerical value of the parameters.

Notwithstanding that numerical ranges and parameters setting forth the broad scope of the invention are approximations, numerical values set forth in the specific examples are reported precisely as possible. Any numerical value, however, inherently contains certain errors necessarily resulting from the standard variation found in its respective testing measurements.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

Reference throughout the specification to “various examples,” “some examples,” “one example,” “an example,” or the like means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The amendment of this specification to add such incorporated subject matter will comply with the written description, sufficiency of description, and added matter requirements.

Whereas particular examples of this invention have been described above for purposes of illustration, it will be evident to those skilled in the art that numerous variations of the details of the present invention may be made without departing from the invention as defined in the appended claims.

While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed and not as more narrowly defined by particular illustrative aspects provided herein.

It is understood that the inventions described in this specification are not limited to the examples summarized in the Summary or Detailed Description. Various other aspects are described and exemplified herein.

What is claimed is:

1. A piece of edible cutlery, the piece of edible cutlery comprising:
a main flour; and
a binder.

2. The piece of edible cutlery of claim 1, wherein the main flour comprises a main grain flour comprising a range of approximately 50% to approximately 70% starch by total dry weight of the main grain flour.

3. The piece of edible cutlery of claim 1, wherein the main flour is selected from the group consisting of: a wheat flour, a rice flour, a corn flour, a chickpea flour, an oat flour, and a millet flour.

4. The piece of edible cutlery of claim 3, wherein the main flour comprises:
approximately 80% to approximately 98% of the wheat flour by total dry weight of the piece of edible cutlery;
approximately 0.8% to approximately 8% of the rice flour by total dry weight of the piece of edible cutlery;
approximately 0.6% to approximately 6% of the corn flour by total dry weight of the piece of edible cutlery;
approximately 0.4% to approximately 4% of the chickpea flour by total dry weight of the piece of edible cutlery; and
approximately 0.2% to approximately 2% of the oat flour by total dry weight of the piece of edible cutlery.

5. The piece of edible cutlery of claim 1, wherein the binder is selected from the group consisting of: a rice flour, an oat flour, a soy flour, a corn flour, a chickpea flour, a tapioca starch, and a cassava starch.

6. The piece of edible cutlery of claim 1, wherein the binder facilitates gelatinization of a gelatin content in the main flour to enable the piece of edible cutlery to be formed.

7. The piece of edible cutlery of claim 1, wherein the piece of edible cutlery is suitable for human consumption.

8. The piece of edible cutlery of claim 1, wherein the edible cutlery comprises:
approximately 80% to approximately 98% of the main flour based on the total dry weight percent of the piece of edible cutlery; and
approximately 2% to approximately 20% of the binder and optionally additional ingredients.

9. The piece of edible cutlery of claim 8, wherein the edible cutlery comprises:
approximately 92% to approximately 96% of the main flour based on the total dry weight percent of the edible cutlery; and
approximately 4% to approximately 8% of the binder and optionally additional ingredients.

10. The piece of edible cutlery of claim 8, wherein the main flour comprises wheat flour.

11. The piece of edible cutlery of claim 8, wherein each of the additional ingredients are selected from the group consisting of: a flavoring and a sweetener.

12. The piece of edible cutlery of claim 11, wherein the flavoring is selected from the group consisting of: a salt, a black pepper, a mint, a caraway, a cumin, a curry, a vanilla, and a cocoa powder.

13. The piece of edible cutlery of claim 11, wherein the sweetener is selected from the group consisting of: a sugar, a sorbitol, and a maltodextrin.

14. The piece of edible cutlery of claim 1, wherein the piece of edible cutlery softens in a food at a temperature of approximately 212° F. in a time range of approximately 15 minutes to approximately 30 minutes.

15. The piece of edible cutlery of claim 1, wherein the piece of edible cutlery softens in a food at a temperature in a range of approximately 6° F. to approximately 10° F. in a time range of approximately 45 minutes to approximately 120 minutes.

16. The piece of edible cutlery of claim 1, wherein the piece of edible cutlery is selected from the group consisting of: a spoon, a dessert spoon, a fork, a knife, a spork, a straw, a chopstick, an ice cream stick, a coffee stirrer, a cup, a bowl, and a plate.

17. A method for manufacturing a piece of edible cutlery, the method comprising:
mixing a main flour and a binder with water to form a dough;
kneading the dough;
rolling the dough to a predefined thickness;
precision cutting the dough into a predefined shape for the piece of edible cutlery;
compressing the dough into molds to strengthen the shape for the piece of edible cutlery;
disposing the molds into an oven for a temperature and time suitable to reduce the water content in the dough to form the edible cutlery; and
removing the edible cutlery from the molds.

18. The method of claim 17, wherein the main flour is present in an amount of approximately 80% to approximately 98% based on the total dry weight percent of the piece of edible cutlery.

19. The method of claim 17, wherein the binder is present in an amount of approximately 2% to approximately 20% based on the total dry weight percent of the piece of edible cutlery.

20. The method of claim 17, further comprising:
subjecting the edible cutlery to a quality control, wherein the quality control comprises determining if the edible cutlery has a predefined shape, a predefined smoothness, a predefined texture, a predefined strength, and/or a predefined hardness.
